(19) United States
(12) Patent Application Publication
(10) Pub. No.: US 2024/0036210 A1
(43) Pub. Date: Feb. 1, 2024

(54) LASER RADAR SYSTEM, AND SPATIAL MEASUREMENT DEVICE AND METHOD

(71) Applicant: Rayz Technologies (Suzhou) Co. Ltd., Suzhou City (CN)

(72) Inventors: Ruxin CHEN, Beijing (CN); Detao DU, Beijing (CN)

(21) Appl. No.: 18/487,869

(22) Filed: Oct. 16, 2023

Related U.S. Application Data
(63) Continuation of application No. PCT/CN2021/087666, filed on Apr. 16, 2021.

(51) Int. Cl. G01S 17/894; G01S 17/42; G01S 7/4863; G01S 7/481; G01S 7/487

(52) U.S. Cl. CPC G01S 17/894; G01S 17/42; G01S 7/4863; G01S 7/4817; G01S 7/4815; G01S 7/487

(57) ABSTRACT

A laser radar system and a spatial measurement method are provided. The laser radar system comprises: a light-emitting unit array, comprising at least one light-emitting unit that is provided at a preset light-emitting position and can control the charactristics-information of emitted light; an optical scanning unit, configured to generate a scanning angle for transmitting light M intended for scanning a target scenario, and determine a first control scanning angle; a light-receiving unit array, comprising at least one light-receiving unit configured to receive the charactristics-information of reflected light after the emitted light passes through the target scenario; and a processor for determining at least one of the scanning angle and a distance between the target scenario and the light-receiving unit according to the preset light-emitting position, the first control scanning angle, the charactristics-information of the emitted light, and the charactristics-information of the reflected light.

### CROSS-REFERENCE TO RELATED APPLICATIONS

The present patent disclosure is a continuation of International Application No. PCT/CN2021/087666, filed on Apr. 16, 2021 titled “LASER RADAR SYSTEM, AND SPATIAL MEASUREMENT DEVICE AND METHOD”, the full text of which is incorporated herein by reference.

### TECHNICAL FIELD

The present disclosure relates to the field of measurement and testing, and specifically to a laser radar system, a space measurement device, a space measurement method and a computer readable storage medium.

### BACKGROUND

As an important sensing tool, laser radar (LIDAR) plays an increasingly important role in many fields. For example, in a current field of autonomous driving, the laser radar is used as an important sensing tool.

The laser radar is a radar system that emits a laser beam to detect a position, a speed and other characteristic variables of a target. A working principle of the radar system is to first emit a detection laser beam to a target scene, and then compare a received signal reflected from the target with an emitted signal. After appropriate processing, relevant charactristics-information of the target can be obtained, for example, parameters of the target such as a distance, an orientation, a height, a speed, a pose and even a shape.

For a conventional laser radar, a plurality of laser emitters are required if three-dimensional scanning (for example, in the range of 360°) is desired to be implemented. However, a cost of a laser emitter used in the laser radar is high, and therefore, the cost of the conventional laser radar using the plurality of laser emitters is also high.

In addition, the conventional laser radar has a large field-of-view and a small angular resolution during scanning and detection in a horizontal direction. However, constrained by the existing technology, the conventional laser radar only has a small field-of-view and a large angular resolution during scanning and detection in a vertical direction, which makes it difficult to meet actual sensing requirements.

In addition, a light reflection signal of the conventional laser radar under the conditions of a high resolution and a long distance is inadequate in anti-interference to sunlight, and inadequate in anti-interference to other laser radars within a short distance, which also makes it difficult to meet actual sensing requirements.

### SUMMARY

An aspect of the present disclosure provides a laser radar system. The laser radar system includes: a light-emitting unit array, comprising at least one light-emitting unit disposed at a preset light-emitting position and capable of controlling charactristics-information of emitted light; an optical scanning unit, used to generate a scanning angle to be used by the emitted light to scan a target scene, and determine a first control scanning angle, wherein the first control scanning angle is an angle that is detected when the optical scanning unit controls the scanning angle to scan the target scene; a light receiving unit array, comprising at least one light receiving unit, the light receiving unit being used to receive charactristics-information of reflected light obtained after the emitted light is reflected through the target scene; and a processor, for determining at least one of the scanning angle and a distance between the target scene and the light receiving unit according to the preset light-emitting position, the first control scanning angle, the charactristics-information of the emitted light, and the charactristics-information of the reflected light.

In an implementation of the present disclosure, the charactristics-information of the emitted light comprises an emission time of the emitted light and a preset optical characteristic change rule used for controlling the charactristics-information of the emitted light; and the charactristics-information of the reflected light comprises a characteristic change rule of the reflected light, a time at which the reflected light arrives at the light receiving unit, and an optical characteristic of the reflected light.

In an implementation of the present disclosure, the processor determines, within a first preset optical characteristic change measurement time, the characteristic change rule of the reflected light according to the charactristics-information of the reflected light that is formed through at least three different scanning angles.

In an implementation of the present disclosure, an optical characteristic of the emitted light comprises at least one of an intensity, a wavelength, polarization, a waveform, a size of a spot, a shape of the spot, a spatial light intensity distribution, a multi-pulse interval, a pulse width, a rising edge width and a falling edge width.

In an implementation of the present disclosure, the emitted light comprises double pulses, wherein a spacing between the double pulses and at least one of a pulse width of a pulse or a falling edge width of the pulse changes according to a period of a first preset optical characteristic.

In an implementation of the present disclosure, the optical scanning unit comprises: at least one or any combination of a rotating prism, a rotating wedge prism, an MEMS, an OPA, a scanning unit for implementing a relative motion between a light-emitting unit and an emission lens, a liquid crystal for controlling a reflection direction and/or a transmission direction of an optical path, a photoelectric crystal, and an acoustic-control optic deflector.

In an implementation of the present disclosure, the light-emitting unit array comprises at least two light-emitting units disposed along a first direction; and the optical scanning unit comprises a rotating polygon mirror, wherein the rotating polygon mirror comprises a rotating shaft having an acute angle with the first direction, and at least two mirror surfaces driven to be rotated by the rotating shaft.

In an implementation of the present disclosure, the at least two mirror surfaces are disposed to have different predetermined included angles with the rotating shaft, light emitted by the at least two light-emitting units is emitted toward the at least two mirror surfaces at different predetermined emission angles, and a difference value between the different predetermined included angles is less than a preset proportion of a difference value between the different predetermined emission angles; and light emitted by any one of the light-emitting units generates at least two different scanning angles used for scanning and detecting the target scene in a second direction not parallel to the first direction, through the at least two mirror surfaces.

In an implementation of the present disclosure, the at least one light receiving unit includes at least one optical narrowband filter used to reduce background light.

In an implementation of the present disclosure, the preset proportion is at least one of 80%, 50%, 30%, or 10%.

In an implementation of the present disclosure, each of the at least two mirror surfaces is at least one or any combination of an optical reflecting mirror and an optical lens, wherein the optical reflecting mirror comprises at least one or any combination of an optical plane mirror, an optical concave mirror, and an optical convex mirror.

In an implementation of the present disclosure, the laser radar system further includes: at least one second-dimension scanning unit, composed of an acousto-optic deflector, an electro-optic deflector, an MEMS, or an OPA and controlled independently, wherein the second-dimension scanning unit, together with the rotating polygon mirror, completes scanning for the target scene in the first direction and the second direction.

In an implementation of the present disclosure, the laser radar system further includes: laser emission fastener, the laser emission fastener connecting the at least two light-emitting units or at least one multi-light-source integrated circuit chip; optical scanning unit fastener, the optical scanning unit fastener being used to accommodate the optical scanning unit; and laser receiving fastener, the laser receiving fastener connecting the at least one light receiving unit or at least one multi-reception-unit integrated circuit chip, wherein the laser emitting fastener and the optical scanning unit fastener are in relative motion.

In an implementation of the present disclosure, the laser radar system further includes: a collimating unit, wherein the collimating unit comprises at least one of an emitted-light collimating unit and a reflected-light focusing unit, or the emitted-light collimating unit and the reflected-light focusing unit refer to the same one component.

In an implementation of the present disclosure, the light-emitting units are disposed on a focal plane of the collimating unit, and the laser emitting fastener moves relative to the collimating unit.

In an implementation of the present disclosure, the laser receiving fastener moves in synchronization with the laser emitting fastener.

In an implementation of the present disclosure, the laser radar system further includes: a two-dimensional imaging photodetector, wherein the two-dimensional imaging photodetector is used to detect a spatial position of a reflection point of the emitted light in the target scene.

In an implementation of the present disclosure, the laser receiving fastener does not move in synchronization with the laser emitting fastener, and a position of the at least one light receiving unit in the light receiving unit array 1400 is respectively acquired to obtain position assistance charactristics-information of the first control scanning angle, wherein the at least one light receiving unit receives reflected light formed after the emitted light is emitted to a part of the target scene at the scanning angle.

In an implementation of the present disclosure, a first light receiving unit, used at least to measure an arrival time of the reflected light; and a second light receiving unit, used only to measure a position of the reflected light, wherein the first light receiving unit and the second light receiving unit are disposed independently.

In an implementation of the present disclosure, the processor respectively communicates with the light-emitting unit array, the light receiving unit array, the optical scanning unit, and the two-dimensional imaging photodetector, and the processor is configured to acquire the spatial position, a measured distance and a light intensity of the reflection point of the target scene based on at least one of the preset light-emitting position and the position assistance information, the predetermined included angles of the mirror surfaces of the rotating polygon mirror, position charactristics-information of the laser emitting fastener, position charactristics-information of the laser receiving fastener, and reflected light formed after the emitted light is reflected by the reflection point of the target scene.

In an implementation of the present disclosure, the at least one light receiving unit comprises: a coaxial light receiving unit, used to receive coaxial optical path reflected light after the emitted light is reflected by the target scene; and a non-coaxial light receiving unit, used to receive non-coaxial optical path reflected light after the emitted light is reflected by the target scene.

In an implementation of the present disclosure, the laser radar system further includes: a collimating unit, comprising at least one coaxial collimating or focusing lens group, wherein the coaxial collimating or focusing lens group is used to collimate the emitted light and focus the coaxial optical path reflected light and the non-coaxial optical path reflected light.

In an implementation of the present disclosure, the laser radar system further includes: a light splitting unit, comprising at least one beam splitter, wherein the beam splitter is disposed on an optical path of the emitted light, and positioned between the collimating or focusing lens group and the optical scanning unit, or between the light-emitting units and the collimating or focusing lens group, and the beam splitter has an inclination angle of 0° to 180° with the optical path.

In an implementation of the present disclosure, at least one or any combination of a reflecting mirror having a slit, a reflecting mirror having a through hole, a partially transmitting and partially reflecting mirror, a reflecting mirror emitting along an edge and complete relative to emitted light, and a polarizing beam splitter.

In an implementation of the present disclosure, the processor respectively communicates with the light-emitting unit array, the coaxial light receiving unit and the non-coaxial light receiving unit, and the processor is configured to discard or acquire, within a preset first reception time, a measured distance and light intensity of a reflection point of the target scene based on a laser pulse series which is formed after the emitted light is reflected by the reflection point of the target scene and which is received by at least one coaxial light receiving unit and at least one non-coaxial light receiving unit.

In an implementation of the present disclosure, the optical scanning unit comprises at least two one-dimensional optical scanning units for scanning in a single direction, or comprises at least one multi-dimensional scanning unit for scanning in two directions, and the optical scanning unit comprises scanning fastener and a scanning fastener controller, the scanning fastener controller controlling at least one of a scanning speed and phase of at least one scanning fastener in at least one scanning direction.

In an implementation of the present disclosure, the optical scanning unit comprises at least one of an integrally formed rotating prism, a separately assembled rotating prism, an oscillating mirror, a photoelectric crystal, a rotating wedge prism, an OPA control component, an acoustic-control optic deflector, and an MEMS.

In an implementation of the present disclosure, the scanning fastener controller sets at least one of the scanning speed and phase of the scanning fastener based on a predetermined scanning fastener change curve.

In an implementation of the present disclosure, at least one optical scanning unit is not used simultaneously by the emitted light and the reflected light.

In an implementation of the present disclosure, the emitted light scans and detects different partial regions of the target scene based on the at least two mirror surfaces of a rotating polygon mirror, at least 50% of scenes of the different partial regions being different.

In an implementation of the present disclosure, the processor determines a reflectivity of a surface of the target scene according to the charactristics-information of the reflected light.

In an implementation of the present disclosure, the light receiving unit array comprises at least two light receiving units, and the at least two light receiving units share at least one electrical signal preamplifier, wherein the electrical signal preamplifier comprises a transimpedance amplifier.

In an implementation of the present disclosure, the at least two light-emitting units are used to simultaneously emit, within a scanning time interval required by a maximum measurement range, emitted light for scanning; and the light receiving unit array comprises at least two different light receiving units corresponding to the at least two light-emitting units, wherein the at least two light receiving units correspond to at least two different electrical signal preamplifier; and at least one of a distance and light intensity of the target scene respectively scanned by the at least two light-emitting units is determined according to the emitted light emitted simultaneously and output signals of the electrical signal preamplifiers.

In an implementation of the present disclosure, the light-emitting unit array comprises at least two light-emitting units sharing at least one capacitor, the capacitor being used to provide a driving light-emitting current.

Another aspect of the present disclosure provides a space measurement method, including: emitting a measurement pulse according to a predetermined scanning angle and a laser pulse characteristic, wherein the scanning angle is formed after light is emitted by one of at least two light-emitting units disposed in a first direction toward each rotating mirror surface of a rotating polygon mirror at a different predetermined emission angle and deflected by the mirror surface, and predetermined included angles each between a mirror surface and a rotating shaft of the rotating polygon mirror are different; receiving a reflected laser pulse within a preset first reception time interval, the reflected laser pulse being formed after the measurement pulse emitted at the scanning angle is reflected by a target scene; and recording a characteristic of the received reflected laser pulse and each sub-part reception time of at least two sub-parts that are included in the reflected laser pulse; and calculating a target distance, a target intensity, and a target measurement credibility that correspond to the scanning angle through an optical pulse characteristic of the measurement pulse, the characteristic of the reflected laser pulse, a predetermined emission angle, the predetermined included angles, and the sub-portion reception time.

In an implementation of the present disclosure, after the emitting a measurement pulse according to a predetermined scanning angle and a laser pulse characteristic, the method further comprises: generating at least two different optical pulse characteristics due to a change of optical pulse characteristics of at least two measurement pulses at intersection parts of the rotating polygon mirror to which the measurement pulses are emitted, wherein a surface area at an intersection part is less than a predetermined intersection percentage of a trajectory segment of the mirror surface.

Another aspect of the present disclosure provides a space measurement method, including: emitting a measurement laser pulse set within a predetermined first pulse set time interval, wherein the measurement laser pulse set comprises at least three pulse series having different scanning angles and different optical pulse characteristics; receiving a reflected laser pulse set within a preset first reception time interval, the reflected laser pulse set being formed after the measurement laser pulse set is reflected by a target scene; and recording optical pulse characteristics of the received reflected laser pulse set; determining that the reflected laser pulse set is received successfully, in response to a correlation between the reflected laser pulse set and the measurement laser pulse set being greater than a preset correlation threshold; and in response to the correlation between the reflected laser pulse set and the measurement laser pulse set being less than or equal to the preset correlation threshold, determining that the reflected laser pulse set is received unsuccessfully, discarding the received reflected laser pulse set, and emitting a measurement laser pulse set again.

In an implementation of the present disclosure, after determining that the reflected laser pulse set is received successfully, the method further comprises: acquiring measured distances and light intensities of a plurality of reflection points of the target scene based on the optical pulse characteristics of the reflected laser pulse set and the optical pulse characteristics of the measurement laser pulse set, wherein the reflected laser pulse set is formed after the measurement laser pulse set is reflected by the plurality of reflection points.

In an implementation of the present disclosure, the method further includes: pre-processing a related laser pulse set at a high speed using a correlation calculation module, and assisting a computing circuit in screening and calculating the related laser pulse set for high-speed pre-processing, wherein the related laser pulse set is at least one of the measurement laser pulse set and the reflected laser pulse set.

In an implementation of the present disclosure, the preset first reception time interval refers to a time period taken to scan a frame or a time period taken to emit measurement pulses at at least three different scanning angles.

In an implementation of the present disclosure, the preset correlation threshold changes as a length of a reception time and a light intensity of the measurement laser pulse set change.

Another aspect of the present disclosure provides a space measurement method, wherein a laser radar system comprises at least two light receiving units, and the method includes: receiving, by the at least two light receiving units, a laser pulse series emitted by at least one light-emitting unit and reflected by a target scene within a first preset time interval, wherein the laser pulse series comprises at least one laser pulse emitted by a given light-emitting unit, and the first preset time interval is a maximum distance flight time interval; receiving, by the at least two light receiving units, the laser pulse series emitted by the at least one light-emitting unit and reflected by the target scene within a second preset time interval, wherein the second preset time interval is an adjacent distance flight time; and discarding, by the at least two photoelectric detection units, at least a part of the laser pulse series accepted within the first preset time interval, in a case that the laser pulse series emitted by the at least one light-emitting unit and reflected by the target scene is not received within the first preset time interval.

In an implementation of the present disclosure, the laser radar system further comprises at least one independent two-dimensional photoelectric detection array unit, and the method further includes: by the two-dimensional photoelectric detection array unit, receiving a laser pulse emitted by the light-emitting unit and reflected and imaged by a partial region of the target scene, acquiring two-dimensional grayscale image charactristics-information of the partial region within the first preset time interval, and calculating at least one adjacent region based on at least one of the two-dimensional grayscale image information and corresponding three-dimensional distance information in the two-dimensional grayscale image information.

In an implementation of the present disclosure, by the two-dimensional photoelectric detection array unit, receiving a laser pulse emitted by the light-emitting unit and reflected and imaged by a partial region of the target scene comprises: receiving, when a distance difference value corresponding to pixels in at least two adjacent regions is less than a first preset distance threshold, at least two corresponding laser pulses in the adjacent regions by the two-dimensional photoelectric detection array unit within the first preset time interval.

In an implementation of the present disclosure, by the two-dimensional photoelectric detection array unit, receiving a laser pulse emitted by the light-emitting unit and reflected and imaged by a partial region of the target scene comprises: discarding when a distance difference value corresponding to pixels in at least two adjacent regions is greater than a first preset distance threshold, at least one of laser pulses reflected by the adjacent regions by the two-dimensional photoelectric detection array unit within the first preset time interval.

In an implementation of the present disclosure, the method further includes: acquiring at least one of a measured distance of the partial region and the dimensional grayscale image information based on a corresponding laser pulse received and not discarded by the two-dimensional photoelectric detection array unit.

Another aspect of the present disclosure provides a space measurement method, including: receiving simultaneously, by a laser radar system, first reflected light, reflected back by a coaxial optical path, of emitted light and second reflected light, reflected back by a non-coaxial optical path, of the emitted light; and performing calculating to accept or discard at least one of a distance and a reflected-light intensity of at least one reflection point of a target scene based on the first reflected light, an optical characteristic of the first reflected light, the second reflected light, and an optical characteristic of the second reflected light.

Another aspect of the present disclosure provides a space measurement method, including: controlling, by a laser radar system, a scanning speed difference or a phase difference of a two-dimensional scanning unit in two scanning directions, and performing calculating to accept or discard at least one of a distance and a reflected-light intensity of at least one reflection point of a target scene based on a recorded scanning angle of the two-dimensional scanning unit in each dimension, a characteristic of a measurement optical pulse, and a characteristic of a reflected optical pulse.

In an implementation of the present disclosure, the laser radar system further comprises a photoelectric detection unit that receives light reflected along a coaxial optical path and the light reflected along a non-coaxial optical path, and the method further comprises: performing calculating to accept or discard at least one of the distance and the reflected-light intensity of the at least one reflection point of the target scene based on an emission angle of the emitted light, a reflection inclination angle of a scanning prism, a coaxially received optical signal and a non-coaxially received optical signal.

In an implementation of the present disclosure, the laser radar system further comprises a two-dimensional scanning unit that controls a scanning speed or a scanning phase, and the method further comprises: performing calculating to accept or discard at least one of the distance and the reflected-light intensity of the at least one reflection point of the target scene based on a coaxially received optical signal and optical characteristic thereof, a non-coaxially received optical signal and optical characteristic thereof, the scanning angle of the two-dimensional scanning unit in the each dimension, a characteristic of the reflected optical pulse and a characteristic of the received optical pulse.

Another aspect of the present disclosure provides a space measurement device, including: a processor; and a memory, storing a computer readable code, wherein the computer readable code, when run by the processor, performs the above space measurement method.

Another aspect of the present disclosure provides computer readable storage medium, storing an instruction, wherein the instruction, when executed by a processor, causes the processor to perform the above space measurement method.

### BRIEF DESCRIPTION OF THE DRAWINGS

After reading detailed descriptions of non-limiting embodiments given with reference to the following accompanying drawings, other features, objectives and advantages of the present disclosure will become more apparent:

FIG. 1 is a schematic diagram of a structure and operation mode of a laser radar system according to an embodiment of the present disclosure;

FIG. 2 is a schematic diagram of generating a scanning angle of emitted light in a laser radar system according to an embodiment of the present disclosure;

FIG. 3 is a flowchart of a space measurement method according to an embodiment of the present disclosure;

FIG. 4 is a schematic diagram of included angles each between a light-receiving mirror surface and a rotating shaft of a rotating polygon mirror according to an embodiment of the present disclosure;

FIG. 5 is a schematic structural diagram of a laser radar system according to an embodiment of the present disclosure;

FIG. 6 is a schematic diagram of scanning trajectories of a laser radar system according to an embodiment of the present disclosure;

FIG. 7 is a schematic diagram of an operation mode of a laser radar system according to an embodiment of the present disclosure;

FIG. 8 is a schematic diagram of a structure and operation mode of a laser radar system according to an embodiment of the present disclosure;

FIG. 9 is a schematic diagram of a structure and operation mode of a laser radar system according to an embodiment of the present disclosure;

FIG. 10 is a schematic diagram of a structure and operation mode of a laser radar system according to an embodiment of the present disclosure;

FIG. 11 is a schematic diagram of a structure and operation mode of a laser radar system according to an embodiment of the present disclosure;

FIG. 12 is a schematic diagram of scanning trajectories of the laser radar system according to FIG. 11;

FIG. 13 is a schematic diagram of an operation mode of a laser radar system according to an embodiment of the present disclosure;

FIG. 14 is a schematic diagram of scanning trajectories of a laser radar system after a non-planar optical element is disposed in a rotating polygon mirror according to an embodiment of the present disclosure;

FIG. 15 is a schematic exploded diagram of the scanning trajectories of the laser radar system after the non-planar optical element is disposed in the rotating polygon mirror according to FIG. 14;

FIG. 16 is a schematic sampling diagram of a photoelectric detection unit after a light-emitting unit array emits a function beam according to an embodiment of the present disclosure;

FIG. 17 is a schematic sampling diagram of a photoelectric detection unit after a light-emitting unit array emits a function beam for many times in adjacent time periods according to an embodiment of the present disclosure;

FIG. 18 is a flowchart of a space measurement method according to an embodiment of the present disclosure.

FIG. 19 is a schematic diagram of an operation mode of a laser radar system according to an embodiment of the present disclosure;

FIG. 20 is a schematic diagram of shared preamplifiers in light emission and light reception according to an embodiment of the present disclosure;

FIG. 21 is a schematic diagram of a space measurement device according to an embodiment of the present disclosure;

FIG. 22 is a schematic diagram of an architecture of a computing device according to an embodiment of the present disclosure; and

FIG. 23 is a schematic diagram of a storage medium according to an embodiment of the present disclosure.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements. The expression “and/or” includes any and all combinations of one or more of the associated listed items.

It should be noted that, in the specification, the expressions such as “first,” “second” and “third” are only used to distinguish one feature from another, rather than represent any limitations to the features. Thus, without departing from the teachings of the present disclosure, the first laser transceiver discussed below may also be referred to as the second first laser transceiver, and vice versa.

In the accompanying drawings, the thicknesses, sizes and shapes of the components are slightly exaggerated for the convenience of explanation. The accompanying drawings are merely illustrative and not strictly drawn to scale. As used herein, the terms “roughly,” “about” and similar terms are used as terms of approximation rather than terms of degree, and are intended to account for the inherent deviations in measured or calculated values that would be recognized by those of ordinary skill in the art.

It should be further understood that the expressions such as “comprise,” “comprising,” “having,” “include” and/or “including” are open-ended rather than close-ended in the specification, and the expressions specify the presence of stated features, elements and/or components, but do not exclude the presence of one or more other features, elements, components and/or combinations thereof. In addition, expressions such as “at least one of,” when preceding a list of listed features, modify the entire list of features rather than an individual element in the list. In addition, the use of “may,” when describing the implementations of the present disclosure, represents “one or more implementations of the present disclosure.” Also, the term “exemplary” is intended to refer to an example or illustration.

Unless otherwise defined, all expressions (including engineering terms and scientific and technical terms) used herein have the same meaning as commonly understood by those of ordinary skill in the art to which the present disclosure belongs. It should be further understood that, unless expressly stated in the present disclosure, words defined in commonly used dictionaries should be interpreted as having a meaning that is consistent with their meaning in the context of the relevant art and should not be interpreted in an idealized or overly formal sense.

It should be noted that the embodiments in the present disclosure and the features in the embodiments may be combined with each other on a non-conflict basis. In addition, unless expressly defined or contradicted by the context, the specific steps included in the method described in the present disclosure are not necessarily limited to the recited order, but may be performed in any order or in parallel. The present disclosure will be described below in detail with reference to the accompanying drawings and in combination with the embodiments.

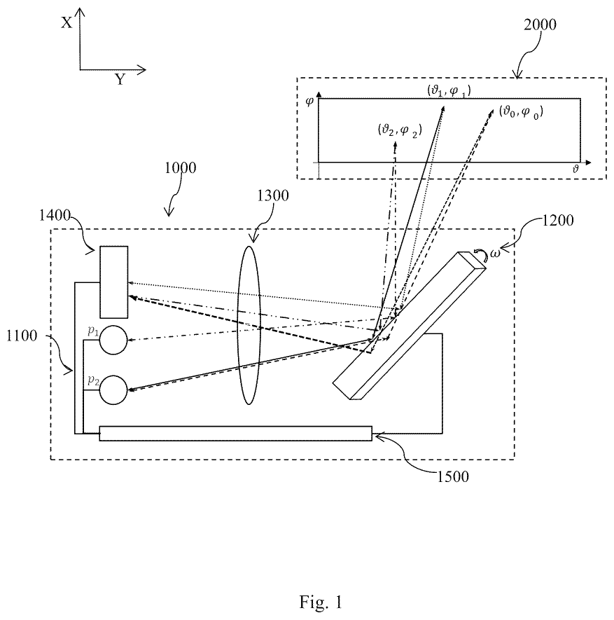

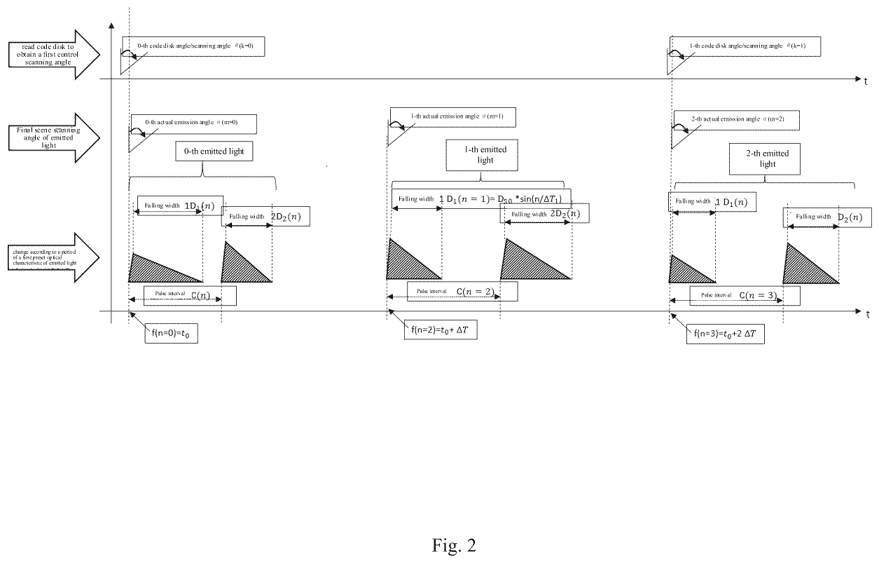

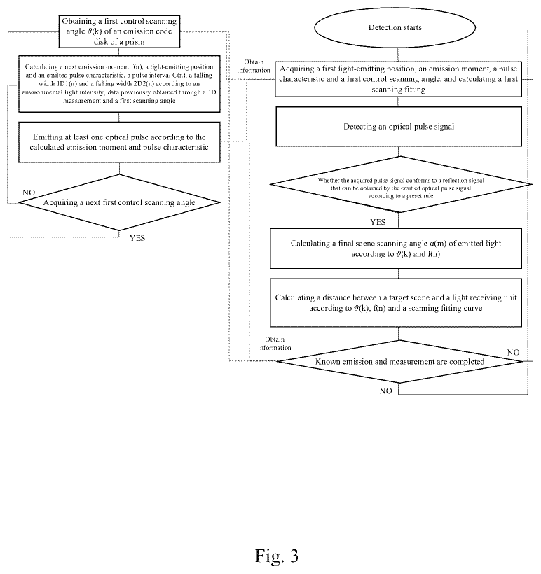

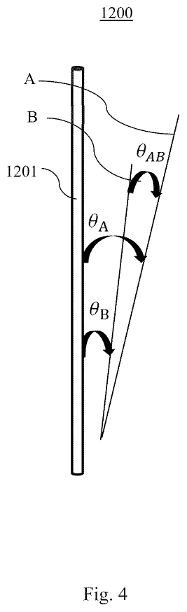

FIG. 1 is a schematic diagram of a structure and operation mode of a laser radar system 1000 according to an embodiment of the present disclosure. FIG. 2 is a schematic diagram of generating a scanning angle of emitted light in a laser radar system 1000 according to an embodiment of the present disclosure. FIG. 3 is a flowchart of a space measurement method according to an embodiment of the present disclosure. FIG. 4 is a schematic diagram of included angles each between a light-receiving mirror surface and a rotating shaft 1201 of a rotating polygon mirror 1200 according to an embodiment of the present disclosure.

The laser radar system 1000 provided in the present disclosure may be used in fields of autonomous driving vehicles, robots, security monitoring, and the like, or may be separately applicable to applications such as a three-dimensional map construction application and an obstacle avoidance application, man-machine interaction, AR/VR, production lines, quality detection, logistics, ports, smart cities, highways, garages, indoor navigation, and games. As shown in FIG. 1, the laser radar system 1000 provided in the present disclosure may include a light-emitting unit array 1100, an optical scanning unit (not shown), a light receiving unit array 1400 and a processor 1500.

The light-emitting unit array 1100 is used to emit a beam that scans and detects a target scene, and the detection beam may be, for example, an infrared laser beam. The light-emitting unit array 1100 includes at least one light-emitting unit disposed at a preset light-emitting position (e.g., p1 and p2 shown in FIG. 1) and capable of controlling charactristics-information of emitted light. In an implementation of the present disclosure, the charactristics-information of the emitted light can be controlled according to a preset optical characteristic change rule.

Alternatively, the light-emitting unit may be an optical fiber laser, a semiconductor laser (e.g., a laser diode (LD) or a vertical cavity surface emitting laser (VCSEL)), a gas laser, a solid-state laser, or the like. The LD or the VCSEL may output a beam in a free space or by optical fiber coupling, and a category of the light-emitting unit and an output mode of the beam may be selected according to an actual condition during implementation, which is not limited in the present disclosure.

The light receiving unit array 1400 is an important part of a laser radar receiving module (not shown), and includes at least one light receiving unit. The light receiving unit is used to receive reflected light obtained after the emitted light is reflected by the target scene 2000, and charactristics-information of the reflected light. The light receiving unit array 1400 may include a plurality of avalanche photo diodes (APDs) arranged in an array, or may include a single large surface element APD, a single photon avalanche diode (SPAD), a silicon photomultiplier (SiPM), or other types of detectors that can be known to those skilled in the art, which is not limited in the present disclosure.

In an implementation of the present disclosure, the at least one light receiving unit may include at least one optical narrowband filter used to reduce background light.

The optical scanning unit is used to increase a scanning range, a scanning coverage resolution and a scanning coverage efficiency of the laser radar system 1000. The optical scanning unit may include a scanning structure mechanically rotating with respect to an emission source, an optical phase-control array scanning structure, a scanning structure in which a light-emitting source and a collimating lens perform a relative motion, a scanning structure in which light is emitted relative to different focal plane positions of the collimating lens, an integral rotary scanning structure in which emission and reception are synchronous, and any combination of at least two of the foregoing scanning structures. Specifically, the optical scanning unit provided in the present disclosure may be used to generate a scanning angle of the emitted light and determine a first control scanning angle. Here, the rotating polygon mirror 1200 is a main part of the optical scanning unit provided in the present disclosure. As an alternative, the vertical direction of the target scene 2000 may be set as a first direction (X direction), the horizontal direction of the target scene 2000 may be set as a second direction (Y direction), and the first direction and the second direction are perpendicular to each other. The rotating polygon mirror 1200 may rotate at a uniform speed and at a certain rotation angle ω in the Y direction, and the rotation angle ω affects the scan angle ϑ at which the laser radar system 1000 scans the target scene 2000 in the Y direction. Further, when the emitted light scans the target scene 2000 at the scanning angle generated after the emitted light passes through the rotating polygon mirror 1200 rotating at the rotation angle ω, an angle that can be detected by an angle detector (code disk) is the first control scanning angle. In other words, the first control scanning angle is an angle that is detected when the optical scanning unit controls the scanning angle to scan the target scene 2000.

In an implementation of the present disclosure, the optical scanning unit includes at least one or any combination of a rotating prism, a rotating wedge prism, an MEMS, an OPA, a scanning unit for implementing a relative motion of a light-emitting unit and an emission lens, a liquid crystal for controlling a reflection direction and/or transmission direction of an optical path, a photoelectric crystal, and an acoustic-control optical deflector.

In an implementation of the present disclosure, the laser radar system 1000 may further include at least one independently controlled second-dimension scanning unit (not shown) composed of an acousto-optic deflector, an electro-optic deflector, an MEMS or an OPA. The second-dimension scanning unit, together with the rotating polygon mirror 1200, completes the scanning for the target scene 2000 in the first direction and the second direction.

In an implementation of the present disclosure, the light-receiving mirror surface of the rotating polygon mirror 1200 may be at least one or any combination of an optical reflecting mirror and an optical lens, the optical reflecting mirror including at least one or any combination of an optical plane mirror, an optical concave mirror, and an optical convex mirror.

In an implementation of the present disclosure, the laser radar system 1000 may further include at least one independently controlled second-dimension scanning unit (not shown) composed of an acousto-optic deflector, an electro-optic deflector, an MEMS or an OPA. The second-dimension scanning unit, together with the rotating polygon mirror 1200, completes the scanning and detecting for the target scene 2000 in the first direction and the second direction.

The processor 1500 respectively communicates with the light-emitting unit array 1100, the optical scanning unit where the rotating polygon mirror 1200 is, and the light receiving unit array 1400. After the echo beam returned from the target scene 2000 is received by the light receiving unit array 1400, a three-dimensional image may be generated after an operation performed by the processor 1500, to complete the detection for the target scene 2000. The processor 1500 may determine at least one of the scanning angle of the emitted light, a surface reflectivity of an emission object, and a distance between the target scene 2000 and the light receiving unit according to the charactristics-information of the emitted light, the preset light-emitting position, the first control scanning angle and the charactristics-information of the reflected light received by the light receiving unit array 1400.

As an alternative, the charactristics-information of the emitted light that is sent by the light-emitting unit array 1100 includes an emission time of the emitted light and the preset optical characteristic change rule used for controlling the charactristics-information of the emitted light. The charactristics-information of the reflected light that is received by the light receiving unit array 1400 includes a characteristic change rule of the reflected light, a time at which the reflected light arrives at the light receiving unit, and an optical characteristic of the reflected light.

In an implementation of the present disclosure, within a first preset optical characteristic change measurement time, the processor 1500 may determine the characteristic change rule of the reflected light according to the charactristics-information of the reflected light that is formed through at least three different scanning angles.

For a conventional laser radar system and a conventional space measurement method, constrained by an actual measurement environment or by a measurement precision and a control precision, the laser radar system cannot measure an accurate scanning angle at which the emitted light scans the target scene, but can only measure the above first control scanning angle of the emitted light. The first control scanning angle of the emitted light cannot accurately correspond to the actual emission time of the dual-pulse emitted light such as having the preset optical characteristic change rule. Therefore, the conventional laser radar system and the conventional space measurement method cannot precisely determine the scanning angle and the distance between the target scene and the light receiving unit.

The present disclosure provides a laser radar system and a space measurement method, through which the scanning angle of the emitted light can be calculated according to the measured emission time of the emitted light, the first control scanning angle, the preset optical characteristic and the preset change rule thereof, the arrival time and the optical characteristic of the reflected light obtained after the emitted light is reflected by the target scene. The calculated scanning angle of the emitted light can accurately correspond to the actual emission time of the emitted light, and thus, the precise detection for the target scene can be completed, thereby determining an actual distance between the target scene and the light receiving unit.

Specifically, in an implementation of the present disclosure, the optical characteristic of the above emitted light may include, for example, at least one of an intensity, a wavelength, polarization, a waveform, a size of a spot, a shape of the spot, a spatial distribution of light intensity, a multi-pulse interval, a pulse width, a rising edge width and a falling edge width of the emitted light.

Further, as shown in FIG. 2, in an implementation of the present disclosure, when the emitted light includes a dual-pulse laser, an interval of the dual-pulse laser and at least one of pulse widths of pulses or falling edge widths of the pulses may change according to a period of a first preset optical characteristic. In other words, the optical characteristic of the dual-pulse laser such as a dual-pulse interval C(n) may change periodically over time t, and each scanning line or the actual time at which double pulses are emitted each time in each frame is determined by an independent time control period control function f(n)=t0+ΔT. Here, n is zero or a positive integer. For example, a width of a first pulse may periodically change over time t according to a period D1(n)=D10×sin(n/ΔT1), and a width of a second pulse may also change over the time t according to a period D2(n)=D10×sin(n/ΔT2). Here, n is zero or a positive integer.

The laser scanning system 1000 may determine whether the optical characteristic of the received reflected light conforms to a preset optical characteristic of the emitted light within a certain past time period (e.g., within 10 microseconds) in a calculation tolerable error range through the acquired first control scanning angle, a dual-pulse emission moment TOF(n), the width period change function D1(n) of the first pulse, the width period change function D2 (n) of the second pulse, and the pulse interval C(n). If the optical characteristic of the received reflected light conforms to the preset optical characteristic, a time of flight of the emitted light and the distance between the target scene 200 and the light receiving unit can be calculated, and the scanning angle (ϑ, φ) at which the emitted light scans the target scene can be determined according to the first control scanning angle and the detected dual-pulse emission moment TOF(n), for example, (ϑ₀, φ₀), (ϑ₁, φ₁) and (ϑ₂, φ₂) shown in FIG. 1. Here, ϑ is the scanning angle of the laser radar system 1000 for the target scene 2000 in the Y direction, and φ is the scanning angle of the laser radar system 1000 for the target scene 2000 in the X direction.

As shown in FIG. 3, in an implementation of the present disclosure, the laser radar system 1000 may calculate an emission moment and a light-emitting position and an optical characteristic of an emitted pulse of next emitted light according to an environmental light intensity, previously measured data and the first control scanning angle obtained through, for example, an angle detector (code disk). Here, the optical characteristic of the emitted pulse may include a pulse interval C(n), a falling width D1(n) of a first pulse laser, and a falling width D2(n) of a second pulse laser. Then, at least one optical pulse is emitted according to the emission moment TOF(n) and the optical characteristic of the emitted light that are obtained through the above calculation result, and a next first control scanning angle is obtained. After the laser radar system 1000 is ready to start detecting the target scene 2000, a first scanning fitting curve at a plurality of scanning angles can be determined according to the information obtained in the above process, a pulse signal of reflected light can be obtained using the light receiving unit array 1400, and it can be determined whether the obtained pulse signal of emitted light conforms to the preset optical characteristic of the emitted light. If so, the scanning angle of the emitted light can be determined or the scanning angle within a previously predetermined time can be corrected based on the current and previous first control scanning angles, the preset optical characteristic of the emitted light, and the first scanning fitting curve, and the distance between the irradiated target scene 200 and the light receiving unit can be determined according to the above information. The detection for the target scene 2000 can be accomplished by repeating the above process.

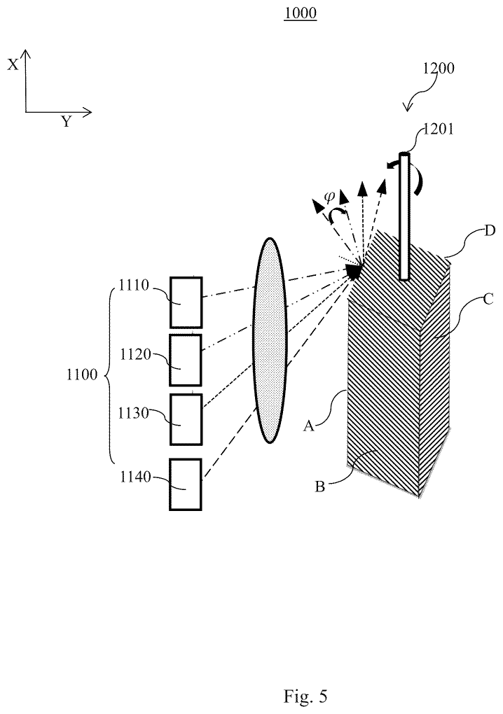

FIG. 4 is a schematic diagram of included angles each between a light-receiving mirror surface and a rotating shaft of a rotating polygon mirror according to an embodiment of the present disclosure. FIG. 5 is a schematic structural diagram of a laser radar system according to an embodiment of the present disclosure.

As shown in FIGS. 4 and 5, in an implementation of the present disclosure, a light-emitting unit array 1100 may include four light-emitting units, which are respectively a light-emitting unit 1110, a light-emitting unit 1120, a light-emitting unit 1130, and a light-emitting unit 1140. As an alternative, the light-emitting units may be arranged in an X direction.

The rotating polygon mirror 1200 includes a rotating shaft 1201 and at least two light-receiving mirror surfaces driven by the rotating shaft. The light-receiving mirror surfaces and the rotating shaft 1201 may have different predetermined included angles, which are acute angles. In an implementation of the present disclosure, the rotating polygon mirror 1200 may include four light-receiving mirror surfaces, which are respectively a light-receiving mirror surface A, a light-receiving mirror surface B, a light-receiving mirror surface C, and a light-receiving mirror surface D. There is a predetermined included angle θ_{A} between the light-receiving mirror surface A and the rotating shaft 1201, and there is a predetermined included angle θ_{B} between the light-receiving mirror surface B and the rotating shaft 1201. There is a difference value θ_{AB} between the predetermined included angle θ_{A} and the predetermined included angle θ_{B}. Correspondingly, the predetermined included angles, each between a light-receiving mirror surface A-D and the rotating shaft 1201, are all different, and thus, the predetermined included angles have a difference value between any two of them. As an alternative, the difference value between the predetermined included angles of some light-receiving mirror surfaces may be very small, and the difference value between the predetermined included angles of some light-receiving mirror surfaces may be very large. In other words, the directions of some light-receiving mirror surfaces in a three-dimensional space may be slightly different, and as another alternative, the directions of some light-receiving mirror surfaces in the three-dimensional space may be greatly different.

The light-emitting units in the light-emitting unit array 1100 may respectively emit light toward the rotating polygon mirror 1200 at different predetermined emission angles. After passing through at least two light-receiving mirror surfaces, the light emitted from any one of the light-emitting units generates different scanning angles, and forms at least two different scanning trajectories for scanning and detecting a target scene 2000. In other words, after passing through at least two light-receiving mirror surfaces of the rotating polygon mirror 1200, the light emitted by any one of the light-emitting units generates at least two different scanning angles used for scanning and detecting the target scene 2000 in a second direction not parallel to a first direction.

When the emitted light from the light-emitting unit array 1100 is emitted to some light-receiving mirror surfaces of the rotating polygon mirror 1200 of which the directions are slightly different in the three-dimensional space, a number of scanning lines of the laser radar system 1000 scanning and detecting the target scene in a vertical direction may be increased, thereby reducing the angular resolution thereof in the vertical direction. When the emitted light from the light-emitting unit array 1100 is emitted to some light-receiving mirror surfaces of the rotating polygon mirror 1200 of which the directions are greatly different in the three-dimensional space, a deflection angle in the direction of the emitted light may be increased, thereby increasing the scanning angle of the laser radar system 1000 in the vertical direction.

During the rotation of the rotating polygon mirror 1200, the light-receiving mirror surfaces may sequentially receive the beams from each of the light-emitting units and generate different scanning angles to scan and detect the target scene in the first direction.

Each difference value between the predetermined included angles, each being between a light-receiving mirror surface of the rotating polygon mirror 1200 and the rotating shaft 1201, may be less than a preset proportion of the difference value between the predetermined emission angles at which the light-emitting units in the light-emitting unit array 1100 emits light to the rotating polygon mirror 1200. In an implementation of the present disclosure, the preset proportion may be at least one of 80%, 50%, 30% or 10%.

FIG. 6 is a schematic diagram of scanning trajectories of a laser radar system 1000 according to an embodiment of the present disclosure.

Referring to FIGS. 5 and 6, the four light-emitting units 1110-1140 according to an embodiment of the present disclosure simultaneously emit pulsed light signals within a time period t, and different scanning angles for scanning and detecting the target scene in the first direction are generated after the pulsed light signals are respectively deflected by the surface A, the surface B, the surface C and the surface D of the rotating polygon mirror 1200. Here, degrees of the scanning angles are all different. For example, there is a difference value φ between first directional scanning angles formed after the light emitted by the light-emitting unit 1110 and light-emitting unit 1120 passes through the surface A of the rotating polygon mirror 1200. A certain difference value of the scanning angles may increase the field-of-view of the laser radar system 1000 during the scanning and detection in the vertical direction and/or reduce the angular resolution of the laser radar system 1000 in the vertical direction.

The predetermined emission angles of the four light-emitting units 1110-1140 are different. For example, the predetermined emission angle of the light-emitting unit 1110 is 1110α, and the predetermined emission angle of the light-emitting unit 1120 is 1120α. The predetermined included angles, each being between a light-receiving mirror surface and the rotating shaft 1201, are also different. For example, the predetermined included angles θ_{A}, θ_{B}, and θ_{D} are formed, each being between a light-receiving mirror surface of the light-receiving mirror surfaces A, B, and D and the rotating shaft 1201. Accordingly, there is a difference value θ_{AB} between the predetermined included angles of the light-receiving mirror surfaces A and B, and there is a difference value θ_{BD} between the predetermined included angles of the light-receiving mirror surfaces B and D. Different spot tracks (scanning trajectories) may be formed after the light emitted from the light-emitting unit array 1000 passes through the light-receiving mirror surfaces of the rotating polygon mirror 1200, thereby completing the scanning and detection in the horizontal direction and the scanning and detection in the vertical direction.

The spot tracks of the light-emitting units 1110-1140 are respectively 01, 02, 03 and 04 (the spot track formed after the light of each light-emitting unit passes through the surface C of the rotating polygon mirror 1200 is omitted). Since the emission angles of the light-emitting units 1110-1140 facing the rotating polygon mirror 1200 are all different, and the difference values between any two of the predetermined included angles, each being between a light-receiving mirror surface of the light-receiving mirror surfaces A-D and the rotating shaft 1201, are also different, finally, the laser radar system 1000 including four light-emitting units forms a horizontal scanning field having a field-of-view FOV1 in the horizontal direction, and forms 16 scanning trajectories in the vertical direction (the first direction X), thereby increasing a vertical field-of-view of the laser radar system 1000 and effectively reducing the vertical angular resolution thereof.

A conventional multi-line laser radar typically includes an optical scanning unit (e.g., a rotating polygon mirror), and thus can reflect a laser beam emitted by a laser emitter (e.g., a light-emitting unit) to different directions to implement the scanning and detection within a scanning field. However, the conventional multi-line laser radar has a low density of scanning trajectories and low scanning resolution in the vertical direction, and therefore, the conventional multi-line laser radar can only take into account a large field and angular resolution of the scanning and detection in the horizontal direction.

Further, in the conventional technique, since the vertical resolution of the laser radar is determined by the number of laser emitters per unit length, a method of improving the scanning resolution of the laser radar in the vertical direction is to increase the number of laser emitters per unit length of the laser radar in the vertical direction. However, since a laser emitter has a certain size, and thus cannot be infinitely arranged per unit length. Therefore, the vertical angular resolution of the conventional laser radar is relatively low and the vertical field-of-view is also small, which makes it difficult to meet sensing requirements.

In an implementation of the present disclosure, by disposing at least two light-emitting units in, for example, the first direction (the vertical direction), and by setting the difference value between any two included angles, each being between a light-receiving mirror surface of the rotating polygon mirror and the rotating shaft, to be less than a preset proportion of a difference value between the predetermined emission angles of any two light-emitting units, it is possible to increase the field-of-view of the laser radar during the scanning and detection in the vertical direction and reduce the angular resolution of the laser radar system in the vertical direction, thereby meeting the actual space measurement requirements.

In the above implementation, for ease of explanation, all the light-emitting units of the light-emitting unit array 1100 are set to simultaneously emit laser pulses. Actually, in some other implementations of the present disclosure, the laser radar system 1000 may alternatively include an optical switch (not shown). The optical switch may be used to control the light-emitting units in the light-emitting unit array 1100 to emit laser pulses according to a preset timing sequence. In some other implementations, the light-emitting units are controlled by an electrical signal to emit laser pulses in an unsynchronized manner according to the preset timing sequence.

Further, in an implementation of the present disclosure, for the laser pulse emitted by any one of the light-emitting units and used for scanning and detection, the preset optical characteristic of the emitted light changes at least one time as the scanning angle of any one of the light-receiving mirror surfaces of the rotating polygon 1200 with respect to the second direction are different. Further, any preset optical characteristic of the emitted light is changed after the emitted light passes through different light-receiving mirror surfaces of the rotating polygon mirror 1200.

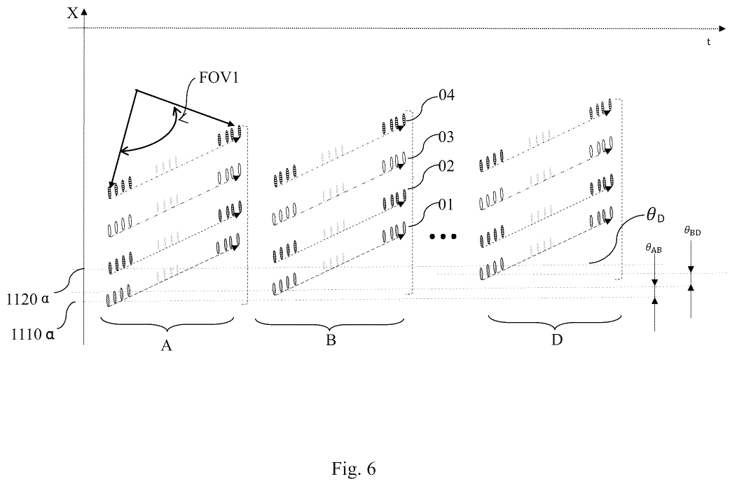

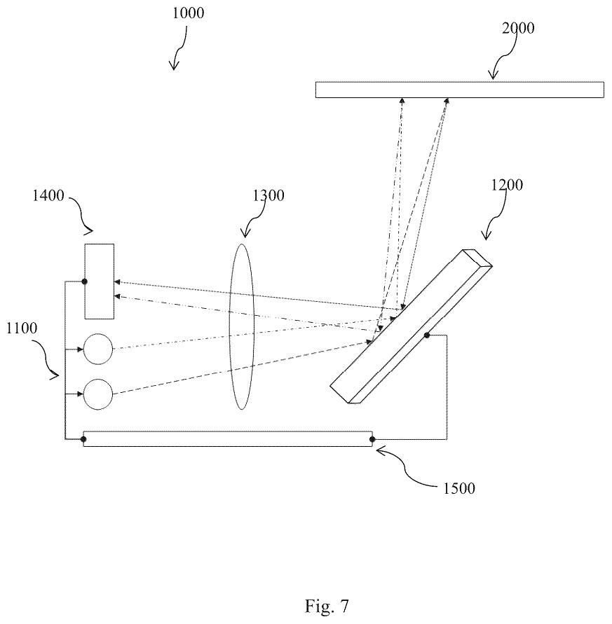

FIG. 7 is a schematic diagram of an operation mode of a laser radar system 1000 according to an embodiment of the present disclosure.

As shown in FIG. 7, in an implementation of the present disclosure, the laser radar system 1000 may include a light-emitting unit array 1100, a rotating polygon mirror 1200, a collimating unit 1300, a light receiving unit array 1400 and a processor 1500.

The collimating unit 1300 may be disposed between the light-emitting unit array 1100 and the rotating polygon mirror 1200 for modulating light emitted from the light-emitting unit array 1100 to parallel beams. The emitted light is deflected by the rotating polygon mirror 1200 after being collimated by the collimating unit 1300, such that the detection light irradiated to a target scene 2000 has a relatively small divergence angle, which can realize the scanning and detection for a remote target. In addition, the detection light after passing through the collimating unit 1300 does not include factors such as aberrations, which can improve the precision of the scanning and detection and simplifies the difficulty of designing the laser radar system 1000. The collimating unit 1300 may be a single lens or a lens group composed of a plurality of lenses.

In an implementation of the present disclosure, a reflected light focusing unit (not shown) may further be disposed between the rotating polygon mirror 1200 and the light receiving unit array 1400. The beam returned after scanning the target scene 2000 will be attenuated after spatial transmission. By disposing the reflected light focusing unit for converging on a light incident side of the light receiving unit array 1400, it is possible to enable the light receiving unit array 1400 to collect as many echo beams as possible.

Further, in an implementation of the present disclosure, the laser radar system 1000 may include at least one emitted-light and reflected-light collimating unit (not shown). The emitted-light and reflected-light collimating unit can not only collimate the emitted light, but also focus the emitted light.

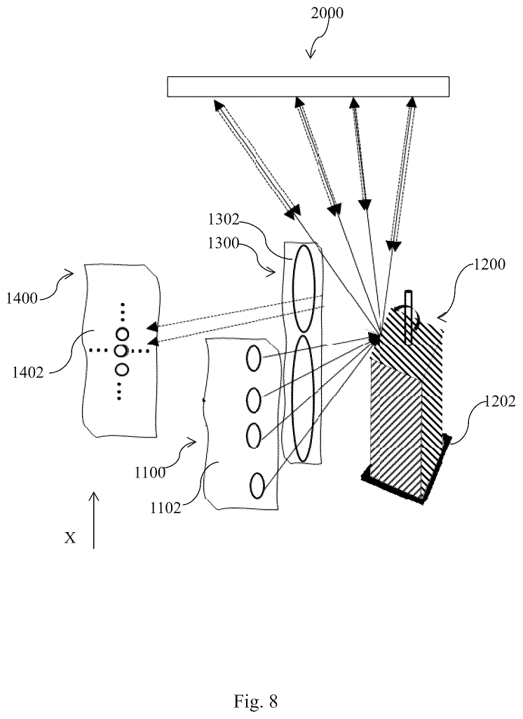

FIG. 8 is a schematic diagram of a structure and operation mode of a laser radar system 1000 according to an embodiment of the present disclosure.

As shown in FIG. 8, in an implementation of the present disclosure, a light-emitting unit may include a fixing piece. Light-emitting units are connected through the fixing piece to form a light-emitting unit array 1100, and the light-emitting unit array 1100 may be disposed on a laser-emitting fastener 1102. Further, the laser emitting fastener 1102 may further connect at least two light-emitting units or at least one light-source integrated circuit chip. In addition, the laser radar system 1000 further includes an optical scanning unit fastener 1202, and the optical scanning unit fastener 1202 may accommodate an optical scanning unit including a rotating polygon mirror 1200. The laser radar system 1000 may further include a laser receiving fastener 1402, and the laser receiving fastener 1402 may connect at least one light receiving unit or at least one multi-reception unit integrated circuit chip. Further, the laser emitting fastener 1102 and the optical scanning unit fastener 1202 are in relative motion.

As an alternative, in an implementation of the present disclosure, the laser emitting fastener 1102 may further move along an X-direction (vertical direction) relative to the optical scanning unit fastener 1202, to increase the resolution of the laser radar system 1000 in the vertical direction. The relative motion may include any one of rotation, vibration and oscillation. The laser beam emitted by the light-emitting unit array 1100 after a one-dimensional vibration changes from a point to a line, and may form more scanning trajectories in the vertical direction after being deflected by the rotating polygon mirror 1200. The number of the laser beams in the vertical direction determines the vertical resolution of the laser radar. The greater the number of the laser beams is, the higher the vertical resolution is. Therefore, the vertical resolution of the laser radar system 1000 can be very high after the light-emitting unit array 1100 moves along the vertical direction relative to the rotating polygon mirror 1200.

As an alternative, the collimating unit 1300 may include a combination of an emitted light collimating unit and a reflected light focusing unit, and the collimating/focusing unit 1300 is fixed to fastener 1302. Further, the light-emitting unit may be disposed on the focal plane of the collimating unit 1300, and the laser emitting fastener 1102 moves with respect to the collimating unit 1300.

Further, in an implementation of the present disclosure, the laser radar system 1000 may simultaneously fix the light-emitting unit array 1100, the rotating polygon mirror 1200, the collimating unit 1300, and the light receiving unit array to the laser emitting fastener 1102, the optical scanning unit fastener 1202, the fastener 1302, and the laser receiving fastener 1402, respectively. As an alternative, the laser receiving fastener 1402 may move in synchronization with the laser emitting fastener 1102. As another alternative, the laser receiving fastener 1402 may not move in synchronization with the laser emitting fastener 1102.

Further, the laser radar system 1000 further includes a two-dimensional photoelectric detection unit for detecting a spatial position of a reflection point of the emitted light in the target scene 2000.

In an implementation of the present disclosure, when the laser receiving fastener 1402 does not move in synchronization with the laser emitting fastener 1102, a position of at least one light receiving unit in the light receiving unit array 1400 is respectively acquired, to obtain position assistance charactristics-information of a first control scanning angle. Here, the at least one light receiving unit receives reflected light formed after the emitted light is emitted to a part of the target scene at the scanning angle.

In an implementation of the present disclosure, a plurality of light receiving units included in the light receiving unit array 1400 may have a first light receiving unit and a second light receiving unit, both of which are independently configured. Here, the first light receiving unit may be used at least to measure an arrival time of the reflected light, and the second light receiving unit is only used to measure the position of the reflected light,

Alternatively, the processor 1500 respectively communicates with the light-emitting unit array 1100, the light receiving unit array 1400, the optical scanning unit and the two-dimensional imaging photodetector. The processor 1500 may acquire a spatial position, a measured distance and a light intensity of a reflection point of the target scene 2000, based on at least one of the preset light-emitting position and the position assistance information, as well as the predetermined included angles of the light-receiving mirror surfaces of the rotating polygon mirror, the position charactristics-information of the laser emitting fastener 1102, the position charactristics-information of the laser receiving fastener 1402, and the reflected light formed after the emitted light is reflected by the reflection point.

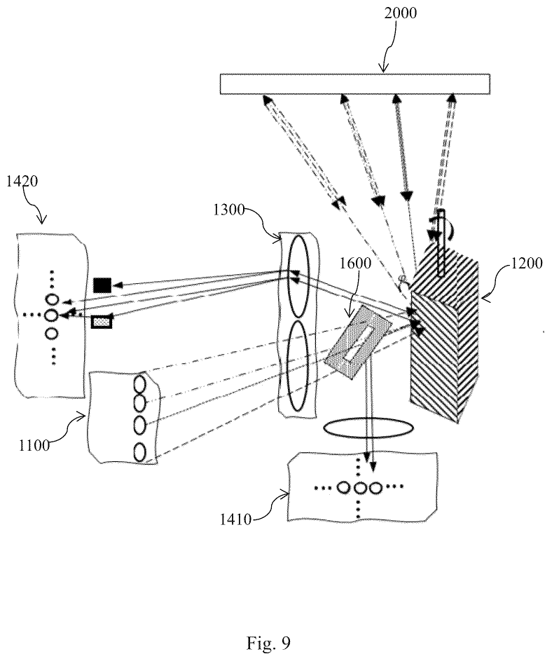

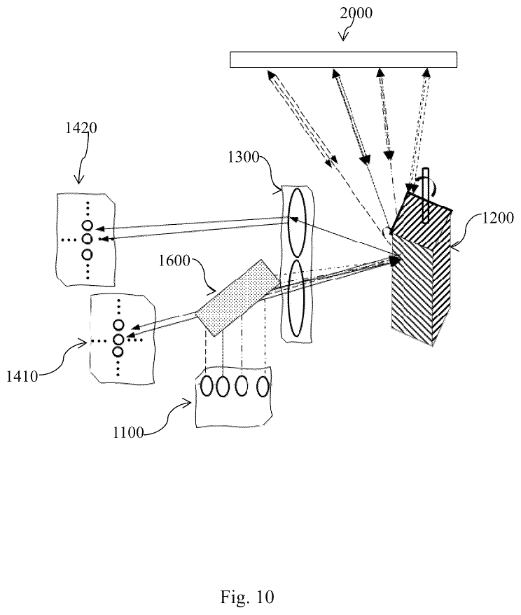

FIG. 9 is a schematic diagram of a structure and operation mode of a laser radar system 1000 according to an embodiment of the present disclosure. FIG. 10 is a schematic diagram of a structure and operation mode of a laser radar system 1000 according to an embodiment of the present disclosure.

As shown in FIGS. 9 and 10, in an implementation of the present disclosure, a light receiving unit array composed of a light receiving units 1400 may further include a coaxial light receiving unit array 1410 and a non-coaxial light receiving unit array 1420. In this implementation, a collimating unit 1300 may include at least one coaxial collimating or focusing lens group, the coaxial collimating or focusing lens group being used to collimate emitted light and focus reflected light.

In addition, in this implementation, a light receiving unit may include at least one coaxial light receiving unit and at least one non-coaxial light receiving unit. The coaxial light receiving unit is used to receive reflected light in a coaxial optical path obtained after the emitted light is reflected by a target scene 2000, and the non-coaxial light receiving unit is used to receive reflected light in a non-coaxial optical path obtained after the emitted light is reflected by the target scene 2000.

In addition, in this implementation, as an alternative, the laser radar system 1000 further includes a light splitting unit 1600, and the light splitting unit 1600 may include at least one beam splitter. The beam splitter may be disposed on an emission light path of a light-emitting unit array 1100, and has an inclination angle of 0° to 180° with the emission light path. For example, the beam splitter may have an inclination angle of 45° with the emission light path. Further, the beam splitter may be positioned between the coaxial collimating or focusing lens group and the rotating polygon mirror 1200, or between the light-emitting unit array 1100 and the coaxial collimating or focusing lens group.

The beam splitter may include at least one or any combination of a reflecting mirror having a slit, a reflecting mirror having a through hole, a partially transmitting and partially reflecting mirror, a reflecting mirror emitting along an edge and complete relative to emitted light, and a polarizing beam splitter.

In an implementation of the present disclosure, when the reflecting mirror having the slit or the through hole is selected as the beam splitter, and is disposed on the emission light path of the light-emitting unit array 1100, the slit or the through hole may allow the emitted light pass therethrough to reach the rotating polygon mirror 1200 without being blocked. In addition, the reflecting mirror having the slit or the through hole may further allow a part of an echo beam returned from the target scene 2000 to be deflected toward the coaxial light-receiving unit array 1410. A group of independent focusing lenses (a coaxial lens group) may be disposed between the beam splitter and the coaxial light receiving unit array 1410 to focus the reflected light onto the coaxial light receiving unit array 1410. At the same time, the non-coaxial light receiving unit array 1420 may receive the remaining part of the reflected light.

In another implementation of the present disclosure, when the partially transmitting and partially reflecting mirror is selected as the beam splitter 1600, and is disposed on the emission light path of the light-emitting unit array 1100, a reflecting surface of the beam splitter 1600 may be coated with a reflective film with a first reflectivity, to allow more than 50% of the emitted light to be emitted toward the rotating polygon mirror 1200 after being reflected by the reflecting mirror. After passing through the partially transmitting and partially reflecting mirror, a part of an echo beam reflected by the target scene 2000 may be radiated toward the coaxial light receiving unit array 1410 with a transmissivity (a second transmissivity). In an implementation, the light-emitting unit array 1100 may further emit polarized light, and the coating of the beam splitter may reflect the emitted light in a first polarization direction on the beam splitter 1600 with a reflectivity greater than 50%. Meanwhile, the beam splitter 1600 makes the echo beam passing through the target scene 2000 transmit therethrough with a transmissivity greater than 50% of the second transmissivity, to reach the coaxial light receiving unit array 1410. In addition, the laser radar system 1000 may further include a reflecting mirror or a combined element of a PBS and a quarter-wave plate, to arrange a narrow-band filter element between a converging lens (or a receiving lens) and the reflecting mirror. Each part of the filter element should have the same filtering parameter.

In the above implementations, a processor 1500 may respectively communicate with the light-emitting unit array 1100, the coaxial light receiving unit array 1410 (coaxial light receiving units) and the non-coaxial light receiving unit array 1420 (non-coaxial light receiving units). The processor 1500 may be configured to acquire, within a preset first reception time period (e.g., a time period in which a frame of data is scanned and collected) and based on the echo beam (a laser pulse series) received by at least one coaxial light receiving unit array 1410 and at least one non-coaxial light receiving unit array 1420, the measured distance and light intensity of a corresponding reflection point of the target scene 2000. By simultaneously using the coaxial light receiving unit array and the non-coaxial light receiving unit array, the laser radar can obtain a larger scanning and detection range. Meanwhile, the detection blind regions can be reduced, and the detection distance and the anti-interference capability can be increased.

According to an other aspect of the present disclosure, a space measurement method is further provided. The method includes: receiving simultaneously, by a laser radar system, first reflected light, reflected by a coaxial optical path, of emitted light and second reflected light, reflected by a non-coaxial optical path, of emitted light, and performing calculating to accept or discard at least one of a distance and a reflected light intensity of at least one reflection point of a target scene based on the first reflected light, an optical characteristic of the first reflected light, the second reflected light, and an optical characteristic of the second reflected light.

Further, the laser radar system further includes a photoelectric detection unit that receives the light reflected along the coaxial optical path and the light along the non-coaxial optical path. The above method further includes: performing calculating to accept or discard at least one of the distance and the reflected light intensity of the at least one reflection point of the target scene based on an emission angle of the emitted light, a reflection inclination angle of a scanning prism, a coaxially received optical signal, and a non-coaxially received optical signal.

In addition, the laser radar system further includes a two-dimensional scanning unit that controls a scanning speed or a scanning phase. The above method further includes: performing calculating to accept or discard at least one of the distance and the reflected light intensity of the at least one reflection point of the target scene based on a coaxially received optical signal and optical characteristic thereof, a non-coaxially received optical signal and optical characteristic thereof, a scanning angle of the two-dimensional scanning unit in each dimension, an optical pulse characteristic of the reflected light, and a optical pulse characteristic of the received light.

FIG. 11 is a schematic structural diagram of a laser radar system 1000 according to an embodiment of the present disclosure. FIG. 12 is a schematic diagram of scanning trajectories of the laser radar system 1000 according to FIG. 11.

As shown in FIG. 11, in an implementation of the present disclosure, the laser radar system 1000 may further include at least two one-dimensional optical scanning units 1700, and the one-dimensional optical scanning units 1700 may control an emitted beam from a light-emitting unit array 1100 and an echo beam from a target scene 2000, thereby realizing different scanning trajectories. The optical scanning units 1700 may be used to scan in a single direction. In addition, as an alternative, the laser radar system 1000 may include at least one multi-dimensional scanning unit (not shown) for scanning in two directions. The optical scanning units 1700 include scanning fasteners (e.g., 1711 and 1712) and scanning fastener controllers (e.g., 1721 and 1722), and the scanning fastener controllers may control at least one of a scanning speed and phase of the scanning fastener. Further, the scanning fastener devices may further set at least one of the scanning speed and phase of the scanning fastener through the processor 1500 based on a predetermined scanning fastener change curve.

As an alternative, the optical scanning units 1700 may include at least one of an integrally-formed rotating prism, a separately-assembled rotating prism, an oscillating mirror, a photoelectric crystal, a rotating wedge prism, an OPA control component, an acoustic-control optical deflector and an MEMS; or another suitable optical scanning unit, which is not limited in the present disclosure.

In addition, in an implementation of the present disclosure, the optical scanning units may not be used simultaneously by the emitted light and the reflected light.

As shown in FIG. 12, scanning trajectories 11 and 12 of the scanning fastener included in the laser radar system 1000 are significantly different when different scanning speeds or phases are selected. The resolution of the laser radar for the target scene can be increased by disposing the optical scanning units 1700 in the laser radar system 1000.

In an implementation of the present disclosure, the emitted light scans and detects different partial regions of the target scene 2000 based on at least two light-receiving mirror surfaces of a rotating polygon mirror 1200, at least 50% of scenes of the different partial regions being different.

In an implementation of the present disclosure, the processor 1500 may determine a reflectivity of a surface of the target scene 2000 based on charactristics-information of the reflected light. Specifically, the charactristics-information of the reflected light includes a time at which the reflected light arrives at a light receiving unit and an optical characteristic of the reflected light such as a light intensity. Here, a distance between the light receiving unit and a partial surface, that corresponds to the reflected light, of the target scene 2000 can be determined according to the time at which the reflected light arrives at the light receiving unit, and the light intensity of the reflected light can affect an intensity of a spot in an image determined from a scanning result. Thus, after a plurality of partial surfaces of the target scene 2000 are scanned, the spot of a partial surface relatively far from the light receiving unit is relatively weak in the image determined from the scanning result. In addition, the spot of a partial surface having a relatively low reflectivity is relatively weak in the image determined from the scanning result. Therefore, considering the above factors, the reflectivity of each part of the surface of the target scene 2000 can be determined.

Further, in a case where the light receiving unit array 1400 includes at least two light receiving units, it is further possible to enable the at least two light receiving units to share at least one electrical signal preamplifier TIA. Here, the electrical signal preamplifier may include a transimpedance amplifier.

In this implementation, the light-emitting unit array 1100 may include at least two light-emitting units that share at least the same capacitor. Here, the capacitor may be used to provide a driving light-emission current. Further, the light receiving unit array 1400 may include at least two different photoelectric receiving units corresponding to the at least two light-emitting units. Here, the at least two photoelectric receiving units correspond to at least two different electrical signal preamplifiers. The at least two light-emitting units may be used to simultaneously emit, within a scanning time interval required by a maximum measuring range, emitted light for scanning. The laser radar system 1000 may determine at least one of a distance of the target scene 2000 respectively scanned by the at least two light-emitting units and a light intensity, according to the emitted light emitted simultaneously and output signals of the electrical signal preamplifiers.

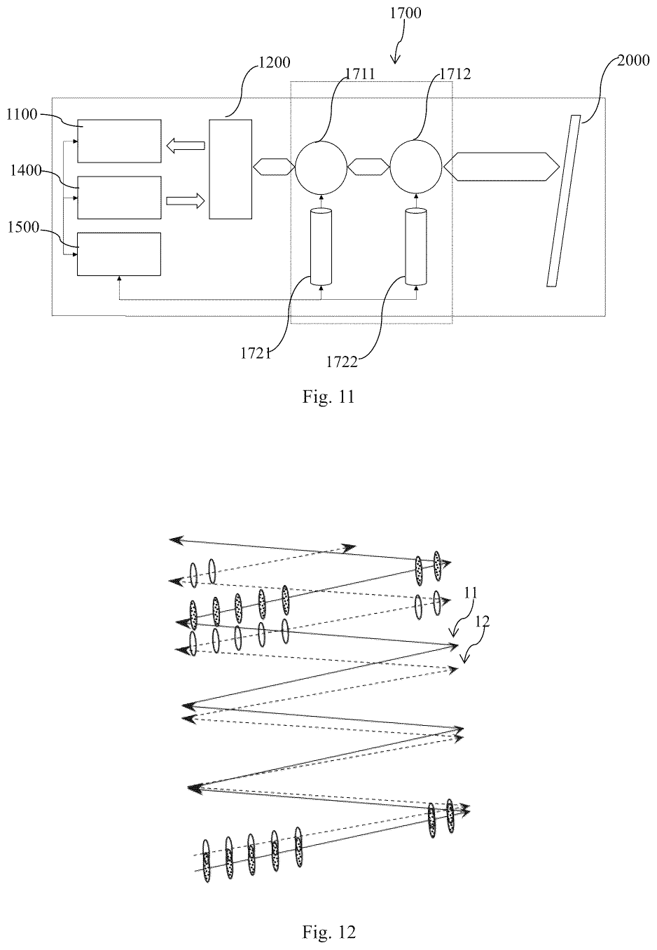

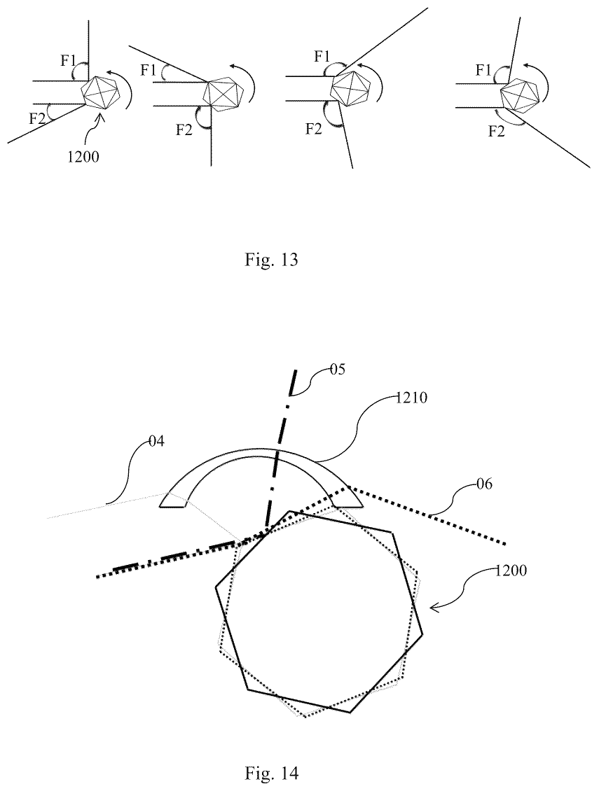

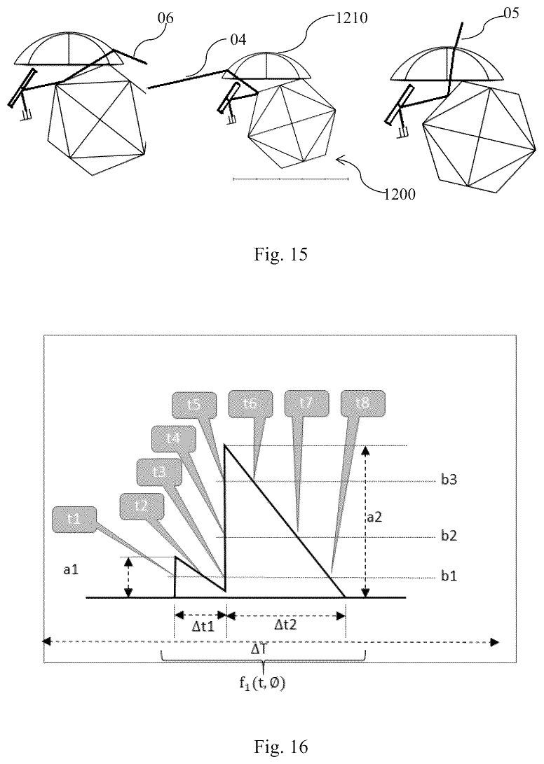

FIG. 13 is a schematic diagram of an operation mode of a laser radar system 1000 according to an embodiment of the present disclosure. FIG. 14 is a schematic diagram of scanning trajectories of a laser radar system 1000 after a non-planar optical element 1210 is disposed in a rotating polygon mirror 1200 according to an embodiment of the present disclosure. FIG. 15 is a schematic exploded diagram of scanning trajectories of the laser radar system 1000 after the non-planar optical element 1210 is disposed in the rotating polygon mirror 1200 according to FIG. 14.

As shown in FIG. 13, in an implementation of the present disclosure, the rotating polygon mirror 1200 included in the laser radar system 1000 may adopt a hexagonal prism which has six light-receiving mirror surfaces. Any two light-emitting units in a light-emitting unit array 1100 are selected to emit scanning beams at the same time or not at the same time. The rotating polygon mirror 1200 rotates at a certain speed, and the scanning beams are deflected by any two light-receiving mirror surfaces of the rotating polygon mirror 1200 to respectively irradiate the front and the rear of the target scene, and respectively form a large front field-of-view F1 and a large rear field-of-view F2. In other words, when the scanning beams (laser pulses) emitted by the light-emitting units in the present disclosure scan and detect different partial regions of the target scene based on at least two surfaces of the rotating polygon mirror 1200, it should be ensured that at least 50% of the scenes of the different partial regions are different, for example, a front region of the target scene and a rear region opposite to the front region.

Further, in order to increase the scanning field-of-view of the laser radar system, a non-planar optical element 1210 may be disposed outside the rotating polygon mirror 1200. As an alternative, the non-planar optical element 1200 may include at least one of a non-planar optical reflecting mirror and a non-planar optical lens. As shown in FIGS. 14 and 15, as the rotating polygon mirror 1200, the hexagonal prism includes at least one non-planar optical element 1210, and rotates at a certain speed during operation of the laser radar system 1000. When an emitted beam is emitted at different prism angles, the same emitted beam may generate different scanning trajectories, for example, scanning trajectories 04, 05 and 06.

According to an other aspect of the present disclosure, the present disclosure further provides a variety of space measurement methods.

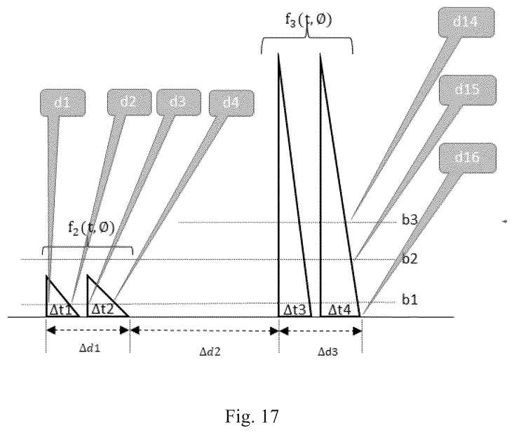

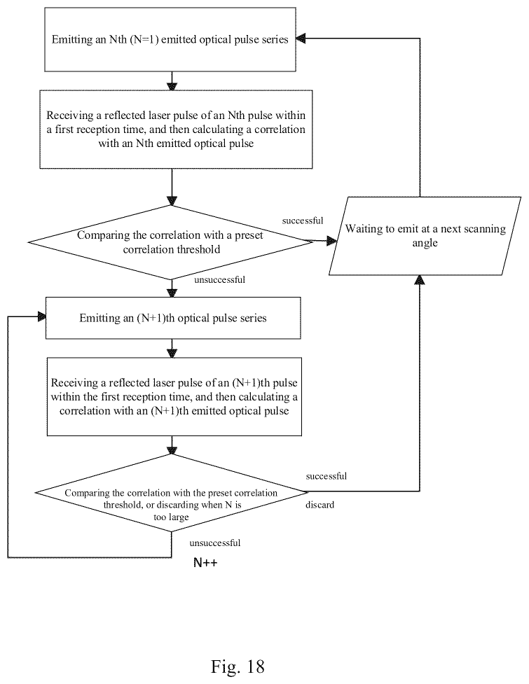

FIG. 16 is a schematic sampling diagram of a light receiving unit array 1400 after a light-emitting unit array 1000 emits a function beam according to an embodiment of the present disclosure. FIG. 17 is a schematic sampling diagram of a light receiving unit array 1400 after a light-emitting unit array 1000 emits a function beam many times in adjacent time period according to an embodiment of the present disclosure. FIG. 18 is a flowchart of a space measurement method according to an embodiment of the present disclosure.

A space measurement method provided in the present disclosure may include: emitting a measurement pulse according to a predetermined scanning angle and a laser pulse characteristic, wherein the scanning angle is formed after light is emitted by one of at least two light-emitting units disposed in a first direction toward each rotating mirror surface of a rotating polygon mirror at a different predetermined emission angle and deflected by the mirror surface, and predetermined included angles each between a mirror surface and a rotating shaft of the rotating polygon mirror are different. The method may include: receiving a reflected laser pulse within a preset first reception time interval, the reflected laser pulse being formed after the measurement pulse emitted at the scanning angle is reflected by a target scene; and recording a characteristic of the received reflected laser pulse and each sub-part reception time of at least two sub-parts that are included in the reflected laser pulse. The method may include: calculating a target distance, a target intensity, and a target measurement credibility that correspond to the scanning angle through an optical pulse characteristic of the measurement pulse, the characteristic of the reflected laser pulse, a predetermined emission angle, the predetermined included angles, and the sub-portion reception time.

In an implementation of the present disclosure, after the emitting a measurement pulse according to a predetermined scanning angle and a laser pulse characteristic, the method further includes: generating at least two different optical pulse characteristics due to a change of the optical pulse characteristics of at least two measurement pulses at intersection parts of the rotating polygon mirror to which the measurement pulses are emitted, wherein a surface area at an intersection part is less than a predetermined intersection percentage of a trajectory segment of the mirror surface.

As shown in FIG. 16, another space measurement method provided in the present disclosure may include: emitting a measurement laser pulse set within a predetermined first pulse set time interval, wherein the measurement laser pulse set comprises corresponding to at least three pulse series having different scanning angles and different optical pulse characteristics, and each pulse series includes at least one optical pulse having an identical scanning angle. Here, a scanning angle is formed after a measurement pulse is emitted by at least two light-emitting units disposed in a first direction to each rotating surface of a rotating polygon mirror at different predetermined emission angles and is deflected by the surface. The method may include: receiving a reflected laser pulse set within a preset first reception time interval, the reflected laser pulse set being formed after the measurement pulse set is reflected by a target scene; and recording optical pulse characteristics of the received reflected laser pulse set. The method may include: determining that the reflected laser pulse set is received successfully, in response to a correlation between the reflected laser pulse set and the measurement laser pulse set being greater than a preset correlation threshold; and in response to the correlation between the reflected laser pulse set and the measurement laser pulse set being less than or equal to the preset correlation threshold, determining that the reflected laser pulse set is received unsuccessfully, discarding the received reflected laser pulse set, and emitting a measurement pulse set again.

In an implementation of the present disclosure, the space measurement method further includes: recording a pulse set characteristic of the measurement pulse set after emitting the measurement pulse set. Here, the pulse set characteristic includes optical pulse characteristics of the at least three pulse series.

Further, in an implementation of the present disclosure, the space measurement method further includes: acquiring a measured distance and light intensity corresponding to each reflection point of the target scene based on the optical pulse characteristics of the reflected laser pulse set and the pulse set characteristic of the measurement pulse set, after the reception is successful. Here, the reflected laser pulse set may be formed after the measurement laser pulse set is reflected by a plurality of reflection points.

The optical pulse characteristics (optical characteristics) of a measurement laser pulse and a reflected laser pulse may include, for example, at least one of an intensity, a slope, a waveform, a wavelength, polarization, a size of a corresponding spot, a shape of the spot, a spatial light intensity distribution and a multi-pulse interval at each sampling time point during different emissions and receptions.

In an implementation of the present disclosure, the space measurement method further includes: pre-processing a related laser pulse set at a high speed using a correlation calculation module, and assisting a computing circuit in screening and calculating the related laser pulse set for high-speed pre-processing, wherein the related laser pulse set is at least one of the measurement laser pulse set and the reflected laser pulse set.

The preset first reception time in the space measurement method may refer to time taken to scan a frame or time taken to emit measurement pulses at at least three different scanning angles.

Further, in the statistical measurement method, the emitted measurement pulse set may include N pulse series, and N is a positive integer greater than or equal to 3, and accordingly, the preset first reception time may alternatively refer to a time period taken to emit the N pulse series, or a time period such as 1 ms, 10 ms, 100 ms and 1 s.

In addition, in an implementation of the present disclosure, the preset correlation threshold changes as a length of a reception time and a light intensity of the measurement laser pulse set change.

Specifically, as shown in FIGS. 16 and 17, in an implementation of the present disclosure, a laser pulse f₁ (t, ø) emitted by a light-emitting unit array contains two overlapping triangular waves, of which time widths are different. The time width of the first triangular wave is Δt₁, the time width of the second triangular wave is Δt₂, and Δt₁ is less than Δt₂. Thresholds b1, b2 and b3 are set in a comparator of the light receiving unit array 1400, and meanwhile, the comparator samples a laser beam at sampling time points t1-t8.

$${Cor}_{fg} ( {t}_{0} , ∅ , d ) = \frac{\int {f}_{1} ( t , ∅ ) \times {g}_{1} ( {t}_{0} + t , ∅ , d ) \times dt}{( \int {f}_{1} ( t , ∅ ) \times dt ) \times ( \int {g}_{1} ( t , ∅ , d ) \times dt )} \qquad ( 1 )$$

In the correlation function formula (1), ø is a scanning angle of the laser radar, d is the distance between a reflection point in the target scene and the laser radar system, and g₁(t, Ø, d) is a pulse signal received by a light receiving unit. A correlation function value may be calculated and obtained by performing integral fitting using the values of discrete sampling points. The laser radar system searches for a maximum correlation function value in a preset range of the distance d under the condition that the scanning angle ø is known, and accepts the received optical signal if the maximum value of the maximum correlation function is greater than the preset correlation threshold. Thus, it may transmit the signal data of the reflected light that is received and sampled to the processor 1500.

As shown in FIG. 17, in another implementation of the present disclosure, the light-emitting unit array 1100 emits two laser pulses f₂ (t, ø) and f₃ (t, ø) in adjacent time period. Here, a power of the laser pulse f₂ (t, ø) may be, for example, less than 1 watt, and a power of the laser pulse f₃ (t, ø) may be, for example, greater than 75 watts. The laser pulse f₂ (t, ø) may include the above two triangular waves, and the time widths (pulse widths) of the two triangular waves are both Δ_{d1}. As an alternative, Δ_{d1} may be, for example, less than 10 nanoseconds. The laser pulse f₃ (t, ø) may include two triangular waves, of which the time widths (pulse widths) are both Δ_{d3}, Δ_{d3} being greater than the time width Δ_{d1}. As an alternative, Δ_{d3} may be, for example, less than 20 nanoseconds. The time interval (pulse interval) between the two laser pulses f₂ (t, ø) and f₃ (t, ø) is Δ_{d2}, and Δ_{d2} may be, for example, less than 400 nanoseconds but greater than 10 nanoseconds.

Specifically, the laser radar may first emit the low-power laser pulses f₂ (t, ø). Within the time width Δ_{d1}, the comparator of the light receiving unit array 1400 samples the reflected beam of the above low-power laser pulse at the sampling time points d1-d4 by setting the thresholds b1, b2 and b3 in the comparator. When the maximum value of the maximum correlation function is greater than the preset correlation threshold, the received optical signal is accepted. When the maximum value of the maximum correlation function is less than the preset correlation threshold, the received optical signal is discarded. Then, the high-power laser pulse f₃ (t, ø) having a different pulse width is emitted through the light-emitting unit array 1000, and the above operations are repeated using d14-d16.

In this implementation, the laser radar first emits a low-power pulse. The signal strengths of the received optical signal at various moments are collected by an ADC and/or a multi-threshold comparator. Whether the optical signal is received successfully is determined by a difference between a signal value sampled at a receiving side and a preset correlation reception function. Further, the amplitude of the first laser pulse f₂ (t, ø) is much less than the amplitude of the laser pulse f3 (t, ø).

The above space measurement method takes into account how to receive the echo beam reflected by the target scene in the adjacent time period when the scanning and detection laser beam is emitted. Therefore, the resistance against the interference of other laser radars can be effectively enhanced.

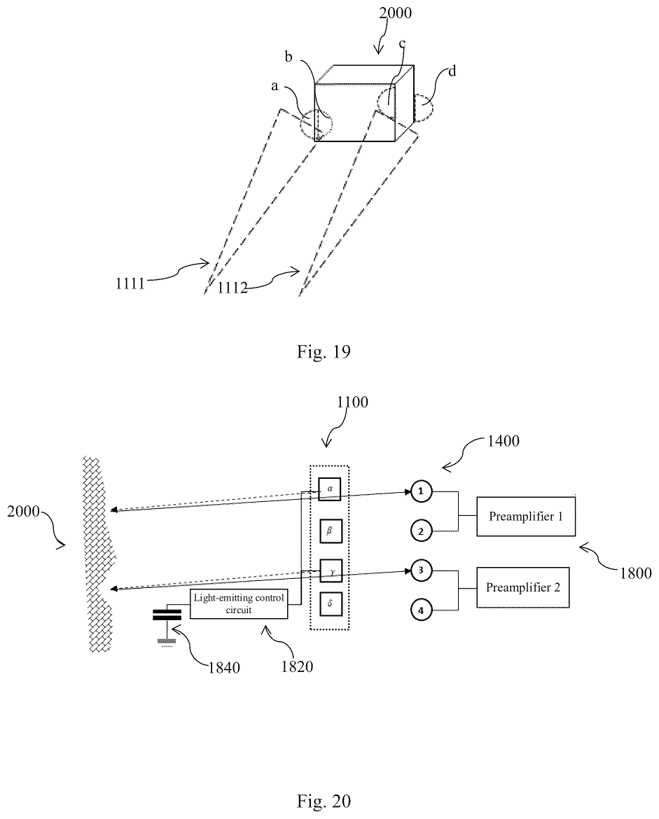

FIG. 19 is a schematic diagram of an operation mode of a laser radar system according to an embodiment of the present disclosure.

As shown in FIG. 19, another space measurement method provided in the present disclosure includes: receiving, by at least two photoelectric receiving units of a laser radar, a laser pulse series emitted by at least one light-emitting unit and reflected by a target scene within a first preset time interval, the pulse series including at least one laser pulse emitted by a given light-emitting unit.

In an implementation of the present disclosure, as an alternative, the first preset time interval may be a time interval during which the laser radar system scans one complete frame of the target scene. Alternatively, the first preset time interval may be a time period during which the laser radar system scans the target scene in a Y direction to form one horizontal scanning trajectory. Alternatively, the first preset time interval may be a time interval during which the laser radar system forms two scanning trajectories during the scanning and detection. Alternatively, the first preset time interval may be a time interval during which the laser radar system forms three scanning trajectories during the scanning and detection. Alternatively, the first preset time interval may be a time interval during which the laser radar system forms 10 consecutive scanning angles during the scanning and detection.

Further, in an implementation of the present disclosure, the at least two photoelectric receiving units may further receive, within a second preset time interval, a plurality of laser pulse series emitted by a plurality of light-emitting units and reflected by the target scene.

In an implementation of the present disclosure, as an alternative, the second preset time interval may refer to one of the time periods during which light flies 1 cm, 2 cm, 5 cm and 1 m.

Further, in an implementation of the present disclosure, a part of the laser pulse series accepted within the first preset time interval is discarded under the condition that not all of the at least two photoelectric receiving units receive the laser pulse series emitted by the plurality of light-emitting units and reflected by the target scene within the second preset time interval.

In addition, in an implementation of the present disclosure, a space measurement device (e.g., a processor) may acquire a measured distance and light intensity of a corresponding reflection point of the target scene based on a laser pulse series received and not discarded by the photoelectric receiving units.

Further, in an implementation of the present disclosure, the photoelectric receiving units include at least one independent two-dimensional photoelectric detection array unit. The two-dimensional photoelectric detection array unit may receive a laser pulse reflected by a partial region of the target scene within the first preset time interval to form two-dimensional grayscale image charactristics-information of the partial region. Specifically, as an alternative, the two-dimensional photoelectric detection array unit may receive, within the first preset time interval, laser pulses reflected by at least two partial regions of the target scene when a distance difference value between the at least two partial regions is less than a first preset distance threshold. As another alternative, the two-dimensional photodetection array unit may discard, within the first preset time interval, a laser pulse reflected by at least one partial region when the distance difference value between the at least two partial regions is greater than the first preset distance threshold.

As shown in FIG. 18, an Nth (N=1) emitted optical pulse series is emitted corresponding to a certain preset scanning angle. A reflected laser pulse of an Nth pulse is received within a first reception time, and then, a correlation with an Nth emitted optical pulse is calculated. Then, the correlation is compared with a preset correlation threshold. If the correlation is greater than the correlation threshold, the reception is successful, and accordingly, a next scanning angle waits to be used for emitting. If the reception is unsuccessful, an (N+1)th optical pulse series is emitted, and the reflected laser pulse of the (N+1)th pulse is received within the first reception time. The correlation between the received reflected laser pulse of the (N+1)th pulse and the emitted (N+1)th optical pulse is calculated. If the reception succeeds or the reception fails too many times, a next scanning angle waits to be used for emitting; otherwise, an (N+2)th optical pulse series is emitted.

Referring again to FIG. 19, the same light-emitting unit emits laser pulses 1111 and 1112 in adjacent time periods, and scanning ranges shown by scanning dashed lines are formed after the laser pulses being deflected by the rotating polygon mirror. For example, the target scene 2000 includes four pixel points (partial regions) a, b, c and d. Here, the pixel points a and b may be irradiated by a first laser pulse 1111, and the pixel point s c and d may be irradiated by a second laser pulse 1112. If the distance between the pixel point s b and c is less than a first distance threshold, the space measurement device may accept the laser pulses reflected by the two partial regions and related optical pulse characteristics. If the distance between the pixel point s b and c is greater than the first distance threshold, at least one of the reflected laser pulses of the laser pulses 1111 and 1112 is discarded.

Further, in an implementation of the present disclosure, the space measurement device may further acquire at least one of the measured distances of the partial regions and the two-dimensional grayscale image information based on the laser pulse received and not discarded by the two-dimensional photoelectric detection array unit.

Through the above space measurement method for adjacent partial regions in the target scene, the capabilities of the laser radar and the space measurement device in resisting a background interference can be enhanced, thereby further improving the ranging precision of the laser radar.

FIG. 20 is a schematic diagram of shared preamplifiers in light emission and light reception according to an embodiment of the present disclosure.

As shown in FIG. 20, a space measurement method provided in the present disclosure further includes: providing at least two light receiving units and at least two light-emitting units of a laser radar. Here, the at least two light receiving units share at least one preamplifier. The light source α and the light source γ of a light-emitting unit array 1100 emit light at the same time to irradiate different parts of a target scene 2000, and the reflected light corresponding to the light is received by a receiving unit of a light receiving unit array 1400 and converted into an electric signal. The light-emitting units of the light-emitting unit array 1100 correspond to the receiving units of the light receiving unit array 1400 one by one. The light-emitting unit α corresponds to the receiving unit 1, the light-emitting unit β corresponds to the receiving unit 2, the light-emitting unit γ corresponds to the receiving unit 3, and the light-emitting unit δ corresponds to the receiving unit 4. The receiving unit 1 and the receiving unit 2 share a preamplifier 1, and the receiving unit 3 and the receiving unit 4 share a preamplifier 2. In addition, a capacitor 1840 can drive, through a light-emitting control circuit 1820, the light source α and the light source δ to emit light simultaneously. By reading the output of the preamplifier 1, and knowing a preset shared circuit component and a preset light-emitting unit combination, the laser radar system reduces a front circuit while achieves the determinations for the light-emitting and receiving units, thereby calculating the distance of the target scene.

Further, the at least two light-emitting units may be used to simultaneously emit, within a scanning time interval required by a maximum measurement range, emitted light for scanning. The light receiving unit array may include at least two different light receiving units corresponding to the at least two light-emitting units. Here, the at least two light receiving units may correspond to at least two different electrical signal preamplifier. At least one of the distance and light intensity of the target scene respectively scanned by the at least two light-emitting units is determined according to the emitted light emitted simultaneously and output signals of the electrical signal preamplifiers.

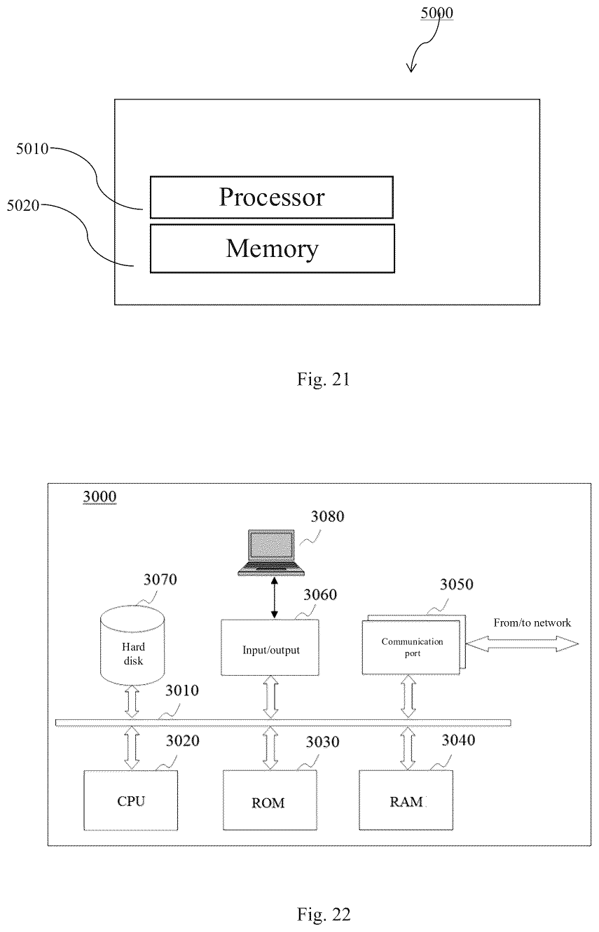

According to an other aspect of the present disclosure, a space measurement device is further provided. FIG. 21 is a schematic diagram of a space measurement device 5000 according to an embodiment of the present disclosure.

As shown in FIG. 21, the device 5000 may include one or more processors 5010, and one or more memories 5020. Here, a memory 5020 stores a computer readable code. The computer readable code, when run by the one or more processors 5010, may perform the space measurement method described above.

The method or apparatus according to the embodiment of the present disclosure may alternatively be implemented by means of the architecture of the computing device 3000 shown in FIG. 22. As shown in FIG. 22, the computing device 3000 may include a bus 3010, one or more CPUs 3020, a read-only memory (ROM) 3030, a random access memory (RAM) 3040, a communication port 3050 connected to a network, an input/output component 3060, a hard disk 3070, and the like. The storage device (e.g., the ROM 3030 or the hard disk 3070) in the computing device 3000 may store various data or files used for the processing and communication in the space measurement method provided in the present disclosure and program instructions executed by the CPU. The computing device 3000 may further include a user interface 3080. Clearly, the architecture shown in FIG. 22 is exemplary only. During the implementation of a different device, one or more components in the computing device shown in FIG. 22 may be omitted according to actual requirements.

According to the space measurement method and apparatus according to an implementation of the present disclosure, the cost of the space measurement apparatus can be reduced, the field-of-view of the space measurement apparatus during the scanning and detection in a vertical direction can be increased, the angular resolution of the space measurement apparatus in the vertical direction can be reduced, thereby meeting the actual space measurement requirements.

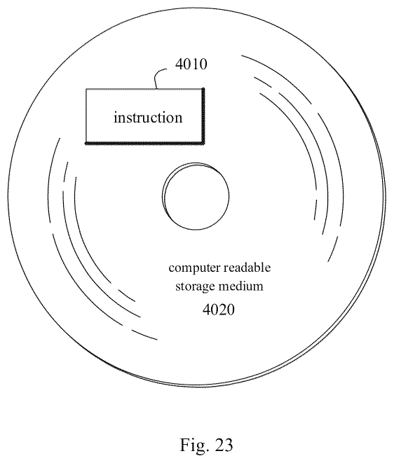

According to an other aspect of the present disclosure, a computer readable storage medium is further provided. FIG. 23 is a schematic diagram of a storage medium according to an embodiment of the present disclosure.

As shown in FIG. 23, a computer storage medium 4020 stores a computer readable instruction 4010. The computer readable instruction 4010, when executed by a processor, may perform the space measurement method according to the embodiments of the present disclosure that is described above with reference to the accompanying drawings. The computer readable storage medium includes, but is not limited to, for example, a volatile memory and/or non-volatile memory. The volatile memory may include, for example, a random access memory (RAM) and a cache memory. The non-volatile memory may include, for example, a read-only memory (ROM), a hard disk and a flash memory.

In addition, according to an implementation of the present disclosure, the process described above with reference to the flowchart may be implemented as a computer software program. For example, the present disclosure provides a non-transitory machine-readable storage medium, the non-transitory machine-readable storage medium storing a machine-readable instruction. The machine-readable instruction can be executed by a processor to execute the instructions corresponding to the method steps provided in the present disclosure, for example, using a laser emitter to emit a laser; using the laser emitter receiving unit to receive the laser emitted by the laser emitter and reflected by an object; and determining a distance information based on the time-of-flight of the reflected laser. In such an implementation, the computer program may be downloaded and installed from a network through a communication interface, and installed from a detachable medium. The computer program, when executed by a central processing unit (CPU), performs the above functions defined in the method of the present disclosure.

The methods, devices, and devices of this application may be implemented in many ways. For example, the methods, devices, and devices of this application can be implemented through software, hardware, firmware, or any combination of software, hardware, and firmware. The above order of steps used for the method is only for illustration, and the steps of the method in this application are not limited to the specific order described above, unless otherwise specified. In addition, in some embodiments, the present application may also be implemented as programs recorded on a recording medium, including machine readable instructions for implementing the method according to the present application. Therefore, the present application also covers a recording medium for storing a program for executing the method according to the present application.

The above description is only for the implementation of the present application and an explanation of the technical principles used. Those skilled in the art should understand that the scope of protection referred to in this application is not limited to technical solutions formed by specific combinations of the aforementioned technical features, but also covers other technical solutions formed by arbitrary combinations of the aforementioned technical features or their equivalent features without departing from the aforementioned technical concept. For example, the technical solution formed by replacing the above features with (but not limited to) technical features with similar functions disclosed in this application.

What is claimed is:

1. A laser radar system, comprising:
a light-emitting unit array, comprising at least one light-emitting unit disposed at a preset light-emitting position and capable of controlling charactristics-information of emitted light;
an optical scanning unit, used to generate a scanning angle to be used by the emitted light to scan a target scene, and determine a first control scanning angle, wherein the first control scanning angle is an angle that is detected when the optical scanning unit controls the scanning angle to scan the target scene;
a light receiving unit array, comprising at least one light receiving unit, the light receiving unit being used to receive charactristics-information of reflected light obtained after the emitted light is reflected through the target scene; and
a processor, for determining at least one of the scanning angle and a distance between the target scene and the light receiving unit according to the preset light-emitting position, the first control scanning angle, the charactristics-information of the emitted light, and the charactristics-information of the reflected light.

2. The laser radar system according to claim 1, wherein,
the charactristics-information of the emitted light comprises an emission time of the emitted light and a preset optical characteristic change rule used for controlling the charactristics-information of the emitted light; and
the charactristics-information of the reflected light comprises a characteristic change rule of the reflected light, a time at which the reflected light arrives at the light receiving unit, and an optical characteristic of the reflected light.

3. The laser radar system according to claim 2, wherein the processor determines, within a first preset optical characteristic change measurement time, the characteristic change rule of the reflected light according to the charactristics-information of the reflected light that is formed through at least three different scanning angles.

4. The laser radar system according to claim 1, wherein,
an optical characteristic of the emitted light comprises at least one of an intensity, a wavelength, polarization, a waveform, a size of a spot, a shape of the spot, a spatial light intensity distribution, a multi-pulse interval, a pulse width, a rising edge width and a falling edge width.

5. The laser radar system according to claim 1, wherein the optical scanning unit comprises:
at least one or any combination of a rotating prism, a rotating wedge prism, an MEMS, an OPA, a scanning unit for implementing a relative motion between a light-emitting unit and an emission lens, a liquid crystal for controlling a reflection direction and/or a transmission direction of an optical path, a photoelectric crystal, and an acoustic-control optic deflector.

6. The laser radar system according to claim 1, wherein,
the light-emitting unit array comprises at least two light-emitting units disposed along a first direction; and
the optical scanning unit comprises a rotating polygon mirror, wherein the rotating polygon mirror comprises a rotating shaft having an acute angle with the first direction, and at least two mirror surfaces driven to be rotated by the rotating shaft.

7. The laser radar system according to claim 6, further comprising: at least one second-dimension scanning unit, composed of an acousto-optic deflector, an electro-optic deflector, an MEMS, or an OPA and controlled independently, wherein the second-dimension scanning unit, together with the rotating polygon mirror, completes scanning for the target scene in the first direction and the second direction.

8. The laser radar system according to claim 1, further comprising:
laser emission fastener, the laser emission fastener connecting the at least two light-emitting units or at least one multi-light-source integrated circuit chip;
optical scanning unit fastener, the optical scanning unit fastener being used to accommodate the optical scanning unit; and
laser receiving fastener, the laser receiving fastener connecting the at least one light receiving unit or at least one multi-reception-unit integrated circuit chip,
wherein the laser emitting fastener and the optical scanning unit fastener are in relative motion.

9. The laser radar system according to claim 8, wherein the processor respectively communicates with the light-emitting unit array, the light receiving unit array, the optical scanning unit, and the two-dimensional imaging photodetector, and the processor is configured to acquire the spatial position, a measured distance and a light intensity of the reflection point of the target scene based on at least one of the preset light-emitting position and the position assistance information, the predetermined included angles of the mirror surfaces of the rotating polygon mirror, position charactristics-information of the laser emitting fastener, position charactristics-information of the laser receiving fastener, and reflected light formed after the emitted light is reflected by the reflection point of the target scene.

10. The laser radar system according to claim 1, wherein the at least one light receiving unit comprises:
a coaxial light receiving unit, used to receive coaxial optical path reflected light after the emitted light is reflected by the target scene; and
a non-coaxial light receiving unit, used to receive non-coaxial optical path reflected light after the emitted light is reflected by the target scene.

11. The laser radar system according to claim 1, wherein
the optical scanning unit comprises at least two one-dimensional optical scanning units for scanning in a single direction, or comprises at least one multi-dimensional scanning unit for scanning in two directions, and the optical scanning unit comprises scanning fastener and a scanning fastener controller, the scanning fastener controller controlling at least one of a scanning speed and phase of at least one scanning fastener in at least one scanning direction.

12. The laser radar system according to claim 11, wherein at least one optical scanning unit is not used simultaneously by the emitted light and the reflected light.

13. The laser radar system according to claim 6, wherein the emitted light scans and detects different partial regions of the target scene based on the at least two mirror surfaces of a rotating polygon mirror, at least 50% of scenes of the different partial regions being different.

14. The laser radar system according to claim 1, wherein the processor determines a reflectivity of a surface of the target scene according to the charactristics-information of the reflected light.

15. The laser radar system according to claim 1, wherein the light receiving unit array comprises at least two light receiving units, and the at least two light receiving units share at least one electrical signal preamplifier, wherein the electrical signal preamplifier comprises a transimpedance amplifier.

16. The laser radar system according to claim 1, wherein
the at least two light-emitting units are used to simultaneously emit, within a scanning time interval required by a maximum measurement range, emitted light for scanning; and
the light receiving unit array comprises at least two different light receiving units corresponding to the at least two light-emitting units,
wherein the at least two light receiving units correspond to at least two different electrical signal preamplifier; and
at least one of a distance and light intensity of the target scene respectively scanned by the at least two light-emitting units is determined according to the emitted light emitted simultaneously and output signals of the electrical signal preamplifiers.

17. A space measurement method, comprising:
emitting a measurement pulse according to a predetermined scanning angle and a laser pulse characteristic, wherein the scanning angle is formed after light is emitted by one of at least two light-emitting units disposed in a first direction toward each rotating mirror surface of a rotating polygon mirror at a different predetermined emission angle and deflected by the mirror surface, and predetermined included angles each between a mirror surface and a rotating shaft of the rotating polygon mirror are different;
receiving a reflected laser pulse within a preset first reception time interval, the reflected laser pulse being formed after the measurement pulse emitted at the scanning angle is reflected by a target scene; and recording a characteristic of the received reflected laser pulse and each sub-part reception time of at least two sub-parts that are included in the reflected laser pulse; and
calculating a target distance, a target intensity, and a target measurement credibility that correspond to the scanning angle through an optical pulse characteristic of the measurement pulse, the characteristic of the reflected laser pulse, a predetermined emission angle, the predetermined included angles, and the sub-portion reception time.

18. A space measurement method, comprising:
emitting a measurement laser pulse set within a predetermined first pulse set time interval, wherein the measurement laser pulse set comprises at least three pulse series having different scanning angles and different optical pulse characteristics;
receiving a reflected laser pulse set within a preset first reception time interval, the reflected laser pulse set being formed after the measurement laser pulse set is reflected by a target scene; and recording optical pulse characteristics of the received reflected laser pulse set;
determining that the reflected laser pulse set is received successfully, in response to a correlation between the reflected laser pulse set and the measurement laser pulse set being greater than a preset correlation threshold; and
in response to the correlation between the reflected laser pulse set and the measurement laser pulse set being less than or equal to the preset correlation threshold, determining that the reflected laser pulse set is received unsuccessfully, discarding the received reflected laser pulse set, and emitting a measurement laser pulse set again.

19. The method according to claim 18, further comprising: pre-processing a related laser pulse set at a high speed using a correlation calculation module, and assisting a computing circuit in screening and calculating the related laser pulse set for high-speed pre-processing, wherein the related laser pulse set is at least one of the measurement laser pulse set and the reflected laser pulse set.

20. A non-transitory computer readable storage medium, storing an instruction, wherein the instruction, when executed by a processor, causes the processor to perform the space measurement method according to claim 17.
